(19) United States
(12) Patent Application Publication
(10) Pub. No.: US 2009/0319312 A1
(43) Pub. Date: Dec. 24, 2009

(54) System and Method for Governance, Risk, and Compliance Management

(75) Inventors: Mark L. Moerdler, Fair Lawn, NJ (US); Christopher S. Boswell, Fort Mill, SC (US); Galina Datskovsky, Fair Lawn, NJ (US); Murali Swaminathan, Fremont, CA (US); Bryan R. Diebold, Shrewsbury, MA (US); Ying Ding, Redwood City, CA (US); John D. Benton, Pullman, WA (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/337,894

(22) Filed: Dec. 18, 2008

Related U.S. Application Data
(60) Provisional application No. 61/081,291, filed on Jul. 16, 2008.
(60) Provisional application No. 61/125,063, filed on Apr. 21, 2008.

(51) Int. Cl. G06Q 10/00; G06Q 50/00

(52) U.S. Cl. 705/7

(57) ABSTRACT

In particular embodiments, the present invention provides a system and method for governance, risk, and compliance management. For example, a method for governance, risk, and compliance management includes providing an interface for defining a control to be used to reach a goal of an organization. The control provides a procedure to be followed by the organization. The method further includes providing the interface for implementing the control in order to reach the goal of the organization. The method further includes receiving metric data from an external source. The metric data includes a document link. The method further includes providing the interface for accessing, using the document link, one or more documents corresponding to the control. The one or more documents are accessed in such a way as to prevent the one or more documents from losing their status as original.

### CROSS-REFERENCE TO RELATED APPLICATIONS

This application claims the benefit of priority under 35 U.S.C. § 119(e) U.S. Provisional Application Ser. No. 61/081,291 filed Jul. 16, 2008, entitled System and Method for Governance, Risk, and Compliance Management, and 61/125,063 filed Apr. 21, 2008, entitled System and Method for Governance, Risk, and Compliance Management. This application is also being filed concurrently with co-pending patent application Ser. No. ______, entitled “______.”

### TECHNICAL FIELD

The present disclosure relates generally to governance, risk, and compliance and more particularly to a system and method for governance, risk, and compliance management.

### BACKGROUND

Organizations ranging from large corporations to small businesses often institute numerous policies, processes, and procedures to help manage the risks, business objectives, and compliance requirements associated with doing business. For instance, a corporation may institute numerous internal controls in order to comply with one or more federal regulations (e.g., the Health Insurance Portability and Accountability Act “HIPPA” or the Sarbanes-Oaxley Act “SoX”), to achieve particular business objectives (e.g., to implement a business objective developed by the organization), or to mitigate particular business risks (e.g., to prevent an identified risk from harming the organization). Consequently, management of such concerns may be important to the overall performance of the organization.

### SUMMARY

In particular embodiments, the present invention provides a system and method for governance, risk, and compliance management. For example, a method for governance, risk, and compliance management includes providing an interface for defining a control to be used to reach a goal of an organization. The control provides a procedure to be followed by the organization. The method further includes providing the interface for implementing the control in order to reach the goal of the organization. The method further includes receiving metric data from an external source. The metric data includes a document link. The method further includes providing the interface for accessing, using the document link, one or more documents corresponding to the control. The one or more documents are accessed in such a way as to prevent the one or more documents from losing their status as original.

Particular embodiments of the present disclosure may enable document links from information governance system 180 to be transferred to system 120, thereby enabling organization 101 to access documents at system 120.

Particular embodiments of the present disclosure may further allow documents managed at information governance system 180 to be accessed at system 120, thereby preventing the documents from losing their status as original.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 illustrates an example organizational structure for an organization;

FIG. 2 illustrates an example system for governance, risk, and compliance management according to an example embodiment of the present disclosure;

FIG. 3 illustrates a more detailed view of particular objects and relationships in the system of FIG. 2;

FIG. 4 illustrates an example network having one or more components which may implement the system of FIG. 2 to provide governance, risk, and compliance management services to the organization of FIG. 1;

FIG. 5 illustrates an example portlet that displays a list of controls;

FIG. 6 illustrates an example portlet that displays a hierarchical view of control objectives and controls.

FIG. 7 illustrates an example portlet that displays example control associations;

FIG. 8 illustrates an example portlet that displays example associations between control objectives and various statutory and regulatory sources;

FIG. 9 illustrates an example graphical display portlet that graphically depicts information about various controls in a graphical form;

FIG. 10 illustrates an example portlet that displays a list of risks to an organization;

FIG. 11 illustrates an example portlet that displays a list of risks to an organization as well as the controls that are being used to mitigate risks;

FIG. 12 illustrates an example graphical display portlet that graphically depicts information about various risks in a graphical form;

FIG. 13 illustrates an example portlet that displays a hierarchical view of requirements and specific requirements;

FIG. 14 illustrates an example portlet that displays a list of baseline standards associated with a particular type of asset;

FIG. 15 illustrates an example view of a portion of the system of FIG. 1 which may enable an organization to track its progress towards accomplishing a particular goal;

FIG. 16 illustrates an example portlet that displays an example list of metrics;

FIG. 17 illustrates an example portlet that displays a list of example metric properties for an example metric;

FIG. 18 illustrates an example portlet that displays an example list of key indicators;

FIG. 19 illustrates an example portlet that displays a list of example key indicator properties for an example key indicator;

FIG. 20 illustrates an example view of a portion of the system of FIG. 1 which may enable an organization to create and manage projects and programs that facilitate the testing of its controls;

FIG. 21 illustrates an example portlet that displays an overview of a testing a program containing a number of testing projects;

FIG. 22 illustrates an example portlet that displays an overview a number of controls tested as part of a program;

FIG. 23 illustrates an example portlet that displays a Testing Project Configuration for a control;

FIG. 24 illustrates an example portlet that displays a testing activity that has been created for a control;

FIG. 25 illustrates an example system for information governance according to an example embodiment of the present disclosure; and

FIG. 26 illustrates an example network having one or more components which may implement the system of FIG. 25 to manage documents of an organization of FIG. 1, and provide metric data to a system of FIG. 2.

### DETAILED DESCRIPTION OF EXAMPLE EMBODIMENTS

Organizational entities (“Organization 101”) ranging from large corporations to small businesses often have a very fragmented view of the current state of their governance, risk, and compliance (“GRC”) sectors. For instance, organization 101 may implement numerous controls 122 to achieve various objectives in each of these sectors. Such efforts may often occur in isolation from one another leading to redundant, inefficient, or even conflicting use of resources, especially in the case of a large organization such as a multinational corporation. Departments within organization 101 may manage organization 101's GRC activities using disparate methods and technologies (e.g., MICROSOFT EXCEL spreadsheets, homegrown applications, word processing documents, MICROSOFT POWERPOINT slides, etc.). As a result, organization 101's various departments may be unable to effectively collaborate with one another, make prudent business decisions, or effectively demonstrate organization 101's compliance efforts to regulators without struggling to do so.

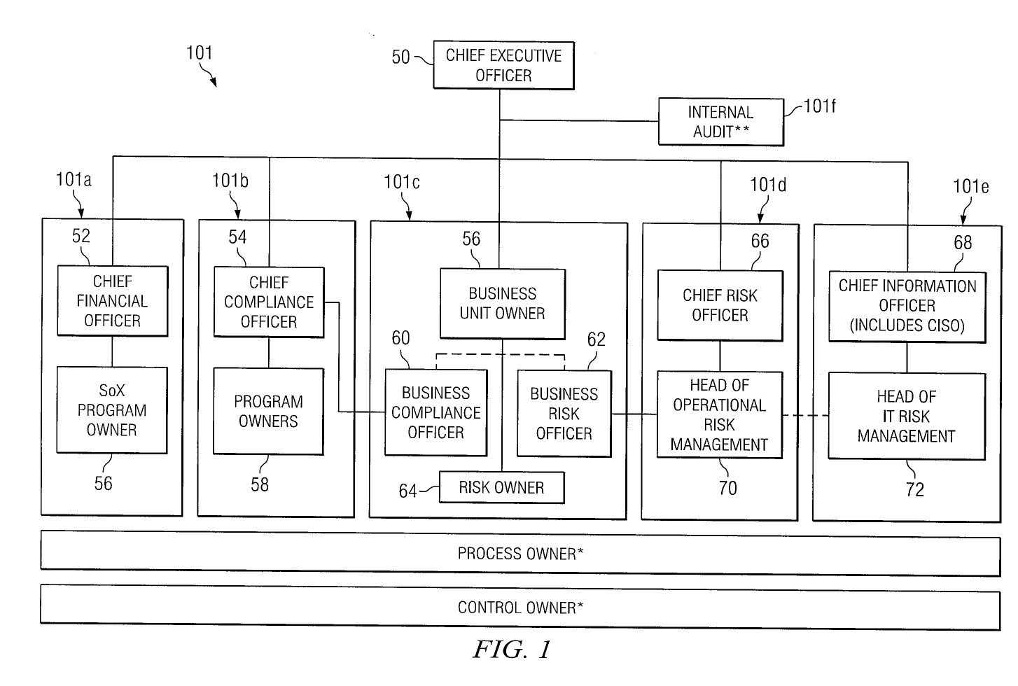

FIG. 1 illustrates an example corporate structure of an example organization 101. Organization 101 may have a Chief Executive Officer (“CEO 50”) that oversees all of organization 101's activities at a high level as well as several separate business departments responsible for managing and maintaining those activities. Below CEO 50 is a Chief Financial Officer (“CFO 52”) that may oversee all of organization 101's activities from a financial perspective and a Chief Compliance Officer (“CCO 54”) who may oversee all of organization 101's activities from a compliance perspective. As part of his financial oversight responsibilities, CFO 52 may oversee a SoX Program Owner 56 who manages organization 101's compliance activities with the Sarbanes-Oxley Act (“SoX”). Likewise, CCO 54 may oversee various other program owners 58 who manage organization 101's compliance activities for various other regulatory requirements 126 (e.g., the Health Insurance Portability and Accountability Act “HIPAA” or Payment Card Industry “PCI” standards).

Organization 101 may further have a business unit owner 56 who oversees organization 101's activities from a business perspective and may oversee a business compliance officer 60 who manages organizations 101's efforts to achieve various business objectives 124 and a business risk officer 62 who manages organizations 101's efforts to mitigate various business risks 128. Business unit owner 56 may also oversee one or more risk owners 64 who are responsible for managing particular risks 128 to organization 101.

Organization 101 may further have a Chief Risk Officer (“CRO 66”) who oversees all of organization 101's activities from a risk management perspective and a Chief Information Officer (“CIO 68”) who oversees all of organization 101's activities from an information management perspective. As part of his risk oversight responsibilities, CRO 66 may oversee a head of operational risk management 70 who manages organization 101's efforts to mitigate various operational risks 128. Likewise, CIO 68 may oversee a Head of Information Technology Risk Management 72 who manages organization 101's efforts to mitigate various information-related risks. Organization 101 may further include an internal audit department 101f responsible for auditing the internal activities of organization 101, for example, to ensure that organization 101 is properly managing its controls 122.

Each of these departments within organization 101 may have overlapping GRC responsibilities within organization 101, and furthermore, may act independently of one another to achieve their various goals within organization 101. Moreover, each of these departments 101a-f may use a host of differing methods, technologies, and computing resources to achieve its own objectives, making it difficult to maintain any uniformity between departments 101a-f. Consequently, organization 101 may suffer from numerous redundant, inefficient, or even conflicting control procedures (e.g., controls 122) that have been implemented in isolation from one by the various departments within organization 101 to achieve their own objectives. For example, the compliance department headed by CCO 54 might focus on managing controls 122 around regulatory requirements 126 while the risk department headed by CRO 66 may focus on managing controls 122 around business risks 128. However, the results of compliance department 101b's activities may be useful for risk management department 101d, for example, in performing risk assessments elsewhere in organization 101 and vice-versa.

In particular embodiments, the present disclosure may provide organization 101 with a system 120 for GRC management that enables organization 101 to collect and organize information regarding all of its GRC-related activities (e.g., business objectives 124, regulatory requirements 126, risks 128, control objectives, 130, and controls 122) in a single, central repository and to present such information to all levels of its infrastructure (e.g., throughout all of its departments 101a-f) using a single platform. Thus, by providing a central repository for organization 101's GRC-related information, system 120 may enable the various departments within organization 101 to coordinate with one another regarding their GRC-related activities. Thus, system 120 may enable organization 101 to increase its Return On Investment “ROI” for its GRC activities by minimizing the amount of redundant work being performed by the departments within organization 101.

One of ordinary skill in the art will appreciate that the above-described embodiments of organization 101 was presented for the sake of explanatory simplicity and will further appreciate that the present disclosure contemplates any suitable organization 101 having any suitable number and type of departments, structure, and officers.

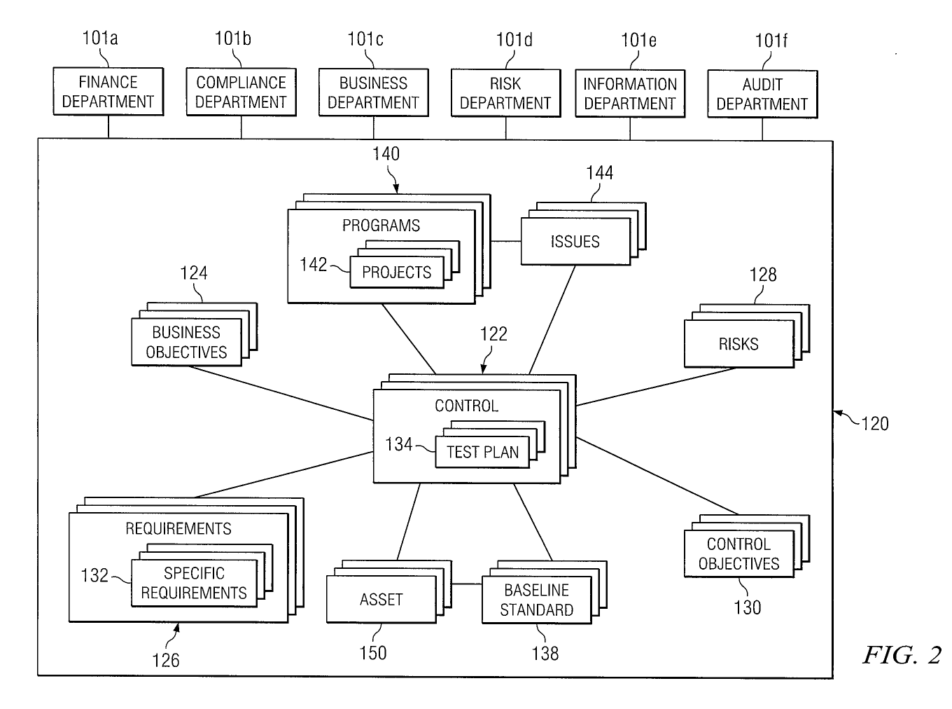

FIG. 2 illustrates an example embodiment of system 120 for providing GRC management services to organization 101 according to the present disclosure. Each of the departments of organization 101 (“departments 101a-f”) may access system 120, for example, to view, add, modify, or delete information from system 120. Thus, system 120 may act as a single, central repository for all of organization 101's GRC-related information. System 120 includes a plurality of controls 122, business objectives 124, requirements 126, risks 128, control objectives 130, and baseline standards 130, each of which represent a logical container for various types of information related to organization 101's GRC activities. In particular embodiments, each of the objects in system 120 may be managed (e.g., sorted, filtered, catalogued, categorized, etc.) within system 120 using, for example, information recorded in various object fields associated with each object.

Controls 122 may represent control procedures or activities that have been developed and implemented by organization 101, for example, to achieve one or more business objectives 124, to comply with one or more regulatory requirements 126, to mitigate one or more risks 128, to manage an asset 150, and/or to establish one or more baseline standards 138. Furthermore, controls 122 may be grouped into one or more larger control objectives 130, that may be implemented in like fashion to achieve business objectives 124, comply with regulatory requirements 126, establish baseline standards 138, manage assets 150, and mitigate risks 128. Consequently, each control 122 may be simultaneously associated with (e.g., linked to), one or more business objectives 124, risks 128, requirements 126, baseline standards 138, assets 150, and control objectives 130. Likewise, each business objective 124, risk 128, requirement 126, baseline standard 138, asset 150, and control objective 130 may be linked to each and every control 122. Thus, controls 122 may relate to each of the objects in system 120 on a many-to-many basis.

In particular embodiments, controls 122 may be implemented, tested, and managed within system 120 as part of one or more larger programs 140 initiated by organization 101 to achieve particular goals (e.g., to achieve business objectives 124, comply with regulatory requirements 126, establish baseline standards 138, manage assets 150, and mitigate risks 128) or remediate particular issues 144 arising from such activities. For example, organization 101 could implement a program 140 to become more environmentally friendly. As another example, organization 101 could implement a program 140 to comply with a particular federal regulation. As another example, organization 101 could implement a program 140 to increase the diversity of its employees. Thus, programs 140 may be used by organization 101 to logically classify its efforts aimed at achieving a particular goal (e.g., program objective).

Each program 140 may have numerous projects 142 associated with it. A project 142 may be, for example, any task undertaken as part of program 140 to accomplish a particular aspect of the larger program objective of program 140. For example, as part of its program 140 to become more environmentally friendly, organization 101 may commence a project 142 to employ energy efficient assets 150 at its facilities. At a more granular level, organization 101 may then implement, test, and maintain the controls 122 to carryout this project 142. For example, organization 101 may implement a control 122 requiring that energy efficient light bulbs be used in its buildings. After this control 122 is implemented, it may be tested. For example, organization 101 may test whether the energy efficient light bulbs are indeed saving energy at organization 101's facilities. Based on the results of the testing, organization 101 may decide wither to maintain this control 122. If a control 122 fails a test, such failure may be recorded as an issue 144 for organization 101 to remediate. For example, if the energy efficient light bulbs are not saving energy, organization 101 may implement another project 142 to remedy this issue 144, for example, by installing skylights as another energy-saving control 122.

By enabling organization 101 to associate each control 122 with a project 142, system 120 may enable organization 101 to effectively weigh one control 122 against another. For instance, in the context of energy-efficient lighting, organization 101 may compare the costs and benefits of using energy efficient light bulbs with the costs and benefits of installing skylights and then may decide whether to implement one, both, or neither of the controls 122.

Moreover, by encapsulating all of organization 101's controls 122 in a single repository and by showing how each of such controls 122 are being used to satisfy a particular objective, system 120 may enable organization 101 to identify and eliminate duplicate or less efficient controls 122. More particularly, the objects in system 120 may grouped into one or more portfolios that may enable organization 101 to assess and prioritize its various GRC-related activates by analyzing the objects in a particular portfolio. To effectively merge GRC management with project & portfolio management, one may assume that compliance projects may not have a logical beginning or end, but rather, may be a never-ending process. Keeping this viewpoint in mind, particular embodiments of system 120 may enable organization 101 to operationalize its GRC activities from the beginning rather than compartmentalizing such efforts into a discrete time frame expecting that they will eventually go away.

For example, organization 101 may have (i) a risk portfolio that organizes and displays all of the risks 128 facing organization 101 as well as the controls 122 that organization 101 is using to mitigate those risks 128, (ii) an asset portfolio that organizes and displays all of the assets 150 of organization 101 as well as the controls 120 that organization 101 is using to manage those assets 150, (iii) a requirement portfolio that organizes and displays all of the requirements 126 with which organization 101 must comply as well as the controls 122 that organization 101 is using to comply with those requirements 125, (iv) a business objective portfolio that organizes and displays all of the business objectives 124 of organization 101 as well as the controls 122 that organization 101 is using to achieve those business objectives 124, and (v) a control objective portfolio that organizes and displays all of the control objectives 130 of organization 101 as well as the controls 122 contained within each of those control objectives 130. Thus, a portfolio may represent a managed set of objects (e.g., assets 150, programs 140, and projects 142) within system 120 mapped to investment strategies that may be based on assumptions about the future performance of strategic and tactical objectives or the risk of not meeting those objectives regarding the objects within a particular portfolio. In particular embodiments, system 120 may enable organization 101 to prioritize its investments in particular GRC-related activities (e.g., controls 122, programs 142, and projects 140) based, for example, on the financial impact of existing GRC-related activities, the potential impact of not implementing certain GRC-related activities, and other quantitative and qualitative considerations related to its GRC-related activities.

For example, if while evaluating organization 101's risk portfolio, a user of system 120 sees that two controls 122 are being used to mitigate the same risk 128, and one of such controls 122 is more efficient than the other, the user may eliminate the less efficient control 122. This process of controls rationalization may also be applied between departments 101a-f to create a harmonized set of controls 122 across organization 101. For instance, if a user of system 120 sees that overlapping controls 122 have been put in place by different departments 101a-f for different purposes but that such controls 122 are redundant, one of such controls may be eliminated. Thus, system 120 may enable organization 101 to harmonize controls 122 across departments 101a-f.

A control 122 may be any measure (e.g., a procedure or an activity) put in place by organization 101 (e.g., departments 101a-f) to ensure that a particular internal or external need of organization 101 is met. As an example and not by way of limitation, a need may arise from organization 101's desire to comply with a requirement 126 of a particular federal regulation, to achieve a particular business objective 124, to establish a particular baseline standard 138, or to mitigate a particular risk 128. As organization 101 develops and implements each new control 122 it may be added to controls 122 for future use. Consequently, system 120 may enable departments 101a-f to recycle existing controls 122 and/or create new controls 122 to achieve their respective objectives as more fully described below.

For example, compliance department 101b may implement, test, and maintain controls 122 in order to comply with various requirements 126. As an example and not by way of limitation, a particular government regulation may impose one or more regulatory requirements 126 on organization 101. These requirements 126 may be stored and catalogued in system 120 to enable compliance department 101b to identify and comply with them. To comply with a requirement 126, a user of system 120 (e.g., a member of compliance department 101b) may access system 120 and search the database of controls 122 that organization currently has in place. For example, controls 122 may be categorized in system 120 using any number of searchable criteria (e.g., name, type, age, etc.). If organization 101 already has a control 122 that satisfies requirement 126, the user may link that control 122 to requirement 126. If organization 101 does not have a control 122 that satisfies requirement 126, the user may create and implement a new control 122 to comply with requirement 126.

By linking requirements 126 with controls 122, system 120 may enable organization 101 to justify or rationalize its reasons for including a particular control 122 in its control portfolio (e.g., for maintaining a particular control 122). For example “strong” controls 122 (e.g., controls 122 that are heavily relied upon by organization 101) may be more justifiable than “weak” controls 122 (controls 122 that are not heavily relied upon by organization 101). For example, organization 101 may define “strong” controls 122 as those controls 122 which mitigate more than four risks 128, are included in at least four control objectives 130, or comply with at least four specific requirements 132. In an effort to maximize its control portfolio, organization 101 may perform a search against the database of controls 122 to identify weak controls 122 (e.g., controls 122 that only satisfy one or two specific requirements 132). Once this list of weak controls 122 is obtained, organization 101 may look at the specific requirements 132 that are met by each of these controls 122 to determine whether additional, compensating controls 122 are in place. After confirming the existence of additional compensating controls for each of these specific requirements 132, the weak controls may be eliminated, thereby optimizing the organization 101's control portfolio.

Additionally, by linking requirements 126 with controls 122, system 120 may enable organization 101 to quickly perform a gap analysis with respect to new legislation. More particularly, organization 101 may quickly identify whether it currently has controls 122 in place which satisfy some or all of the requirements 126 of the new legislation, and second whether the new legislation imposes new requirements 126 on organization 101 which require organization 101 to implement new controls 122. If organization 101 identifies new requirements 126 that are currently out of compliance, such requirements 126 may be logged as issues 144 for organization 101 to remediate. Organization 101 may then implement one or more projects 142 to remediate these issues 144.

As a more specific example, SoX may impose a requirement 126 on organization 101 requiring organization 101 to maintain a secure data network. More specifically, this requirement 126 may further include a specific requirement 132 that more specifically requires organization 101 to maintain secure passwords on each of its computer-based assets 150 (e.g., computers). Accordingly, compliance department 101b may need to ensure that organization 101's passwords remain secure in order to comply with requirement 126. Consequently, compliance department 101b may institute a control 122 requiring that each of its passwords be changed on a routine basis (e.g., every 90 days). Additionally, compliance department 101b may institute an additional control 122 requiring that each of its passwords be at least eight characters long and include at least one number and at least one letter. Thus, compliance department 101b may institute multiple controls 122 to satisfy the requirement 126. Typically, requirements 126 and specific requirements 132 are externally developed and are imposed on organization 101 by an external source (e.g., the government or another regulatory authority). Such requirements 126 may be referred to as external requirements 126. However, in particular embodiments, organization 101 may internally develop and impose requirements 126 on itself as part of an internal policy, procedure, standard, guideline, Service Level Agreement (“SLA”), and/or Operating Level Agreement (“OLA”). Such requirements 126 may be referred to as internal requirements 126. In either case, organization typically develops the controls 122 to comply with requirements 126 internally.

Organization 101 may also implement, test, maintain controls 122 in order to mitigate various risks 128. As an example and not by way of limitation, risk department 101d may identify a risk 128 to organization 101 and may institute one or more controls 122 to mitigate risk 128. Like requirements 126, risks 128 may be stored and catalogued in system 120 to enable organization 101 to identify and mitigate them. To mitigate a risk 128, a user of system 120 (e.g., a member of risk department 101d) may access system 120 and may either search for and link an existing control 122 to risk 128 or create a new control 122 to mitigate risk 128. More specifically, the user may log any unmitigated risks 128 as issues 144 for organization 101 to remediate.

As a more specific example, risk department 101d may identify a risk 128 that organization 101's computer-based assets 150 might be compromised by unauthorized personnel. Accordingly, risk department 101d may need to ensure that organization 101's computer resources remain secure in order to mitigate this risk 128. To mitigate this risk 128, a member of compliance department 101d may access system 120 and may search through controls 122 to determine whether organization 101 has existing controls 122 in place which already mitigate this risk 128. In this case, the user may discover that compliance department 101b previously implemented two controls 122 related to computer password security (as described above) that effectively mitigate this risk 128. Consequently, the user may link these two existing controls to risk 128 and may create new additional controls 122 to further mitigate this risk 128, if needed. Typically, organization 101 internally identifies risks 128 and creates the control(s) 122 to mitigate risks 128.

As another example and not by way of limitation, organization 101 may use similar procedures to define a business objective 124 and institute one or more controls 122 to achieve this business objective 124. Business objectives 124 are typically directed to achieving a particular business-oriented goal of organization 101. Typically, organization 101 internally develops business objectives 124 and the control(s) 122 to achieve business objective 124.

In another situation, organization 101 may link controls 122 to an asset 150 or to a certain group of its assets 150 using system 120. Assets 150 may be, for example, hardware based assets 150, software based assets 150, or capital-based assets 150. For example, IT department 101e may establish a baseline standard 138 containing a standard set of controls 122 that may be applied to a particular class (e.g., type) of assets 150. Thus, a baseline standard 138 may provide a template of controls 122 that may ensure that a particular type of asset 150 is uniformly managed within organization 101. To define a baseline standard 138, a user of system 120 (e.g., a member of IT department 101e) may access system 120 and may add existing controls 122 or create new controls 122 to be included in baseline standard 138. The user may then, link baseline standard 138 to a particular class of assets 150 which may then ensure that such assets are governed according to a standard set of controls 122.

As a more specific example, organization 101 may maintain several Payment Card Industry (“PCI”) servers. Organization 101 may establish a baseline standard 138 for its PCI servers that describes a standard group of controls 122 to be applied to every one of its PCI servers. Baseline standards 138 may be established, for example, to satisfy statutory requirements 126 (e.g., PCI standards may impose a number of requirements 126 on organization 101's PCI servers) or to mitigate risks 128 (e.g., a particular risk 128 may affect organization 101's PCI servers). In any case, organization 101 may establish a baseline standard 138 to ensure that a minimum set of controls 122 are implemented with respect to each instance of a particular type of asset 150. Additionally, baseline standard 138 may automatically apply a standard set of controls to new assets 150 as they are brought online.

To assist organization 101 in managing controls 122, each control 122 may include a number of information fields into which various types of information related to each control 122 may be entered. This information may then be used to accomplish various custodial activities within system 120 related to managing controls 122 (e.g., searching controls 122, filtering controls 122, categorizing controls 122, etc). For example, each control 122 may include a “control name” field that may textually identify control 122. The control name may have a maximum length of 255 characters and may identify control 122 to a user, for example, in various portfolio-based views that associate controls 122 with business objects 124, risks 128, requirements 126, assets 150, baseline standards 138 and control objectives 130. Each control may further include a “control ID” field that may identify each control 122 with a unique alphanumeric string, a “control description” field that may describe the characteristics of each control 122, a “control status” field that may identify whether a particular control 122 has been approved for implementation by one or more members (e.g., employees) of organization 101. Furthermore, each control may further include a “control type” field that may define a category for each control, a “control owner” field that may indicate a particular member of organization 101 responsible for maintaining (e.g., implementing and testing) each control 122, a “control nature” field that may indicate a purpose of each control 122 (e.g., corrective meaning that control 122 was put in place to correct a problem in organization 101 after it has occurred, detective meaning that control 122 was designed to find problems in organization 101, or preventative meaning that control 122 was designed to prevent a foreseeable problem from occurring).

In particular embodiments, system 120 may further enable organization to assess the maturity of each control 122. For instance, a member of organization 101 could define the maturity of a control 122 by selecting answers to a set of predefined questions, for example, how long a particular control has been in existence and/or how may times it has been tested. The results of these questions could provide a quantifiable ranking of maturity (e.g., a value between 1 and 10) for each control 122. Such data could also be displayed graphically. For example, system 120 may provide a graph depicting a number of controls 122 wherein the color of each control 122 identifies a level of maturity (e.g., White—No data, Green—Good (score 7-10), Yellow—Average (score 3-7), and Red—Poor (score 0-3)).

In particular embodiments, system 120 may enable organization 101 to estimate the initial investment value of implementing a control 122, or may enable organization 101 to balance the cost of implementing one control 122 over another control 122. For example, to assist organization 101 to gauge the cost of implementing a particular control 122, each control 122 may include fields that indicate an expected labor cost, an expected monetary cost, an expected implementation time-frame, and an expected lifetime for each control 122. Thus, for example, system 120 may enable organization 101 to assess the economic ramifications associated with implementing or maintaining a particular control 122 before implementing a project 142 to do so.

Once controls 122 are in place, for example, once a particular control 122 has been established within organization 101, each control 122 may be periodically tested to ensure that it is working, for example, to satisfy the corresponding need(s) for which it was implemented (e.g., to comply with a specific requirement 132 or to mitigate a particular risk 128). Since controls 122 may be normalized across all of organization 101's various GRC activities (e.g., requirements 126, risks 128, and business objectives 124), organization 101 may have the ability to test its controls 122 once, and satisfy multiple GRC needs. In particular embodiments, one or more documents describing a test plan 134 may be attached (e.g., electronically attached) to each control 122 to ensure the party responsible for testing each control 122 understands the test. As controls 122 are tested, the test results (e.g., documentation of the testing) may be recorded and linked to each control 122 as evidence that each control 122 has been tested. Moreover, the test results may be linked to requirements 126, business objectives 124, risks 128, and control objectives 130 and reported to members of organization 101 or to certain third parties (e.g., auditors).

To assist organization 101 in defining a test, each test plan 134 may include a “test procedure” field that defines one or more procedures to follow in order to test a particular control 122, an “execution frequency” field that indicates how often (e.g., how often in the course of day-to-day business) a particular control 122 is executed, an “expected sample size” field that indicates how many samples (e.g., instances) of a particular control 122 should be tested, a “tolerable error” field that indicates a threshold number of failures allowed before a control 122 fails a test, a “test frequency” fields that indicates how often a control 122 should be tested (e.g., for audit and compliance purposes).

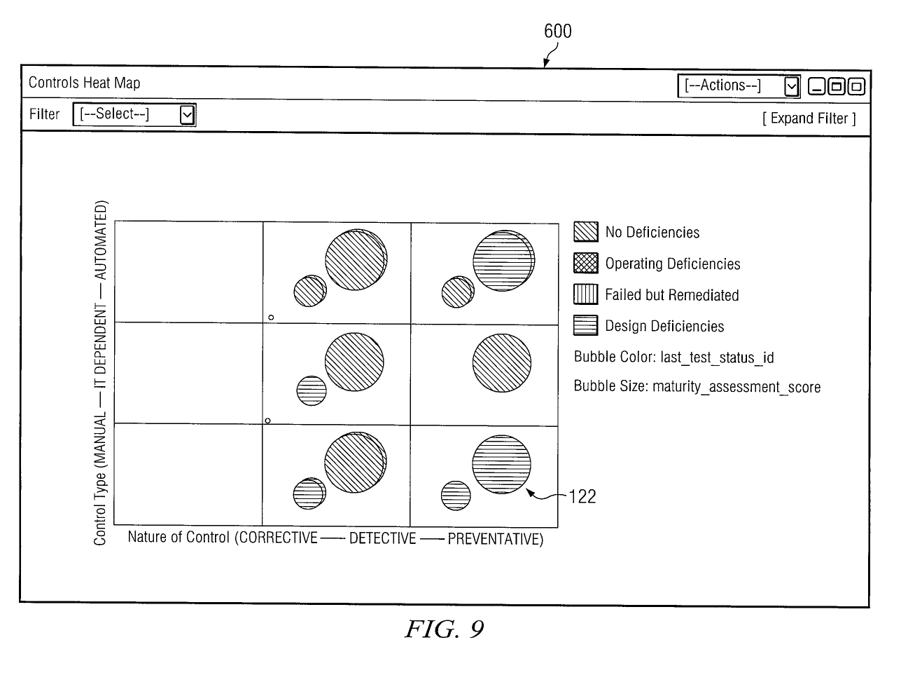

In particular embodiments, each test plan 134 may further include one or more fields associated with documenting the results of a test. For example, test plan 134 may include a “test status” field that indicates whether a test is started, not started, or completed, an “owner” field that identifies the person responsible for maintaining and testing control 122, a “tested by” field that identifies the individual entering the test results, a “test date” field that indicates a date upon which test results were obtained, and “actual sample size” field that indicates how many samples control 122 were tested, a “failed samples” field that indicates how many samples of control 122 failed, and a “test results” field that indicates the result of the test. Each test plan 134 may further include a “deficiencies” field that describes any deficiencies discovered and an “evidence” field that indicates any documentation that supports a particular test result. In particular embodiments, control test data may also be displayed graphically. For example, a user of system 120 may view a graph (See FIG. 9) depicting a number of controls 122 wherein the color of each control 122 identifies a test grade for each control 122 (e.g., Green—passed with no deficiencies, Yellow—passed with deficiencies, Red—failed to pass, and Blue—failed but under remediation). Graphical representations of complex GRC relationships may facilitate organization 101's control normalization process, resulting, for example, in the elimination of redundant, inefficient, or non-performing controls 122.

When a control test fails, a user of system 120 (e.g., the party responsible for testing a control 122) may create an issue 144 associated with the failed control 122 that may, for example, alert a particular member of organization 101 of the issue 144 and provide information as to how the issue 144 may be corrected. Issues 144 may also arise from any number of non-test related activities, for example, external issues 144 could arise from various external sources such as third party audits, regulatory reviews. Likewise, internal issues 144 could arise from various internal sources such as, for example, internal risk assessments or internal gap analyses. Once an issue 144 is identified, organization 101 may implement a program 140 or project 142 to address the issue 144.

In particular embodiments, issues 144 may be aggregated into broader concepts such as significant deficiencies and material weaknesses for specific regulatory reporting purposes (e.g., reporting against regulatory requirements 126). For example, with regard to a SoX compliance program 140, a plurality of issues 144 may arise in the context of control testing (e.g., a number of controls 122 may fail). These issues 144, in aggregate, may represent a material weakness in organization 101's internal controls 122. Accordingly, organization 101 may implement a program 140 to remediate this material weakness.

To assist organization 101 in managing issues, each issue may include an “issue name” field that may textually identify the issue, an “issue ID” field that may identify each issue with a unique alphanumeric string, an “issue owner” field that may indicate a person or entity responsible for addressing the issue, an “issue status” field that may indicate a disposition of the issue (e.g., issue open or issue closed), a “target resolution date” field that may indicate a time frame for resolving the issue, and an “Issue Priority” field that may indicate a level of priority assigned to the issue.

As briefly discussed above, system 120 may further enable organization 101 to group one or more controls 122 into broader control objectives 130. Control objectives 130 may logically group together controls 122 having a similar purpose or achieving a similar outcome. Control Objectives 130 may be effective tools for aggregating, grouping, or classifying similar controls 122. They can be defined very granularly or be represented more abstractly, depending on the audience being targeted. An example of a granularly defined control objective might be “Change passwords on a regular basis.” Organization 101 might have three different controls 122 for changing passwords that may satisfy this control objective 130: (i) for applications with corporate intellectual property, passwords are changed every 60 days, (ii) for applications that process payment card data, passwords are changed every 30 days, and (iii) for all other applications, passwords are changed every 90 days. At the same time, organization 101 may define a control objective 130 at a higher level of abstraction. An example might be “Prevent unauthorized access to systems.” In this example, the same controls 122 mentioned above may apply but may only partially satisfy this higher level control objective 130. To fully satisfy this higher level control objective 130, one or more additional controls 122, or more granular control objectives 130 may be needed.

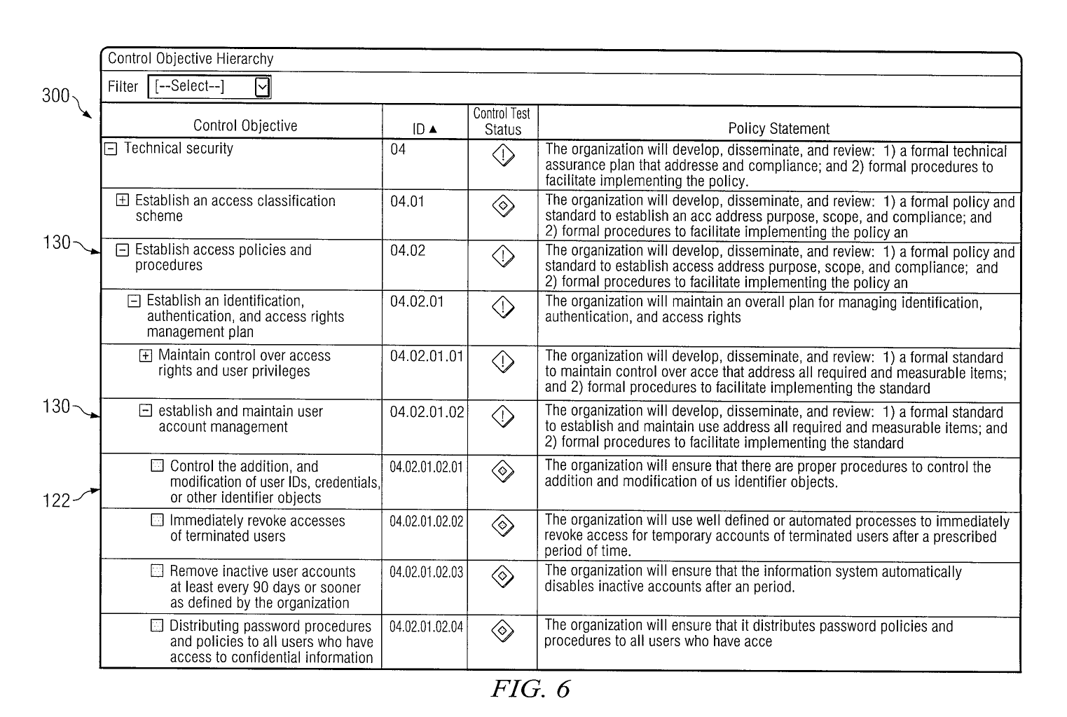

To assist organization 101 in managing broad and granular control objectives 130, control objectives 130 may be hierarchically arranged within system 120 (see FIG. 6). Accordingly, each control objective 130 may have one or more child control objectives 130 directed to a particular purpose within the larger control objective 130. A parent control objective 130 may have numerous child control objectives 130, and each child control objective 130 may have numerous controls 122. In particular embodiments, there may be no limit on the number of levels in the hierarchy of control objectives 130. Thus, the hierarchy of control objectives 130 may enable organization 101 to group controls 122 broadly or granularly (e.g., for reporting purposes). Linking controls 122 to broader control objectives 130 may enable organization 101 to effectively aggregate and report control activities at an executive level. By rolling controls 122 up into higher level control objectives 130, system 120 may enable organization 101 to identify high-level trends across the internal control environment which might otherwise go unnoticed if viewed at a granular level.

Like controls 122, control objectives 130 may be used to comply with a requirement 126 of a particular federal regulation, to achieve a particular business objective 124, to establish a particular baseline standard 138, or to mitigate a particular risk 128 using an aggregation of related controls 122. Because control objectives 130 group like controls 122 together, control objectives 130 may provide an efficient mechanism for reporting results of compliance activities at the executive level. For instance, if a high level executive officer (e.g., CCO 54) wants to know how organization 101 is complying with a particular requirement 126, organization 101's compliance efforts may be reported to CCO 54 in terms control objectives 130 which may be successively rolled to a very high level rather than in terms of individual controls 122 which may number in the thousands. Thus, rather than individually listing each control 122 that is being used to comply with a particular requirement 126, system 120 may simply display the larger control objectives 130 that are being used to comply with requirement 126.

As an example and not by way of limitation, a regulation that requires “Passwords should be changed every 90 days” may be mapped to the above-described control objective 130, “Change passwords on a regular basis.” Thus, rather than explicitly linking each control 122 within control objective 130 to this requirement 126, a user of system 120 may link control objective 130 to requirement 126, thereby implicitly linking each of the controls 122 contained therein to requirement 126. Thus, control objectives 130 may enable a user of system 120 to efficiently link a group of controls 122, for example to a risk 128 or requirement 126. Additionally, linking regulatory requirements 126 to control objectives 130 may help quickly identify gaps in existing control practices, and may effectively reduce the amount of time required to adopt and report against new legislative mandates.

To assist organization 101 in managing control objectives 130, each control objective 130 may include a “control objective name” that textually identifies control objective 130, a “control objective ID” field that may identify each control objective 130 with a unique alphanumeric string, a “policy statement” that identifies a business policy associated with control objective 130, a “control objective parent” field that, if applicable, may identify a parent control objective 130, and an “impacted business areas” field that may define one or more business areas of organization 101 that are impacted by control objective 130.

System 120 may further enable organization 101 to identify one or more risks 128 and to implement one or more controls 122 to mitigate risks 128. A risk 128 may be any threat to organization 101. As an example and not by way of limitation, risks 128 may be physical threats to organization 101's assets 150 such as by fire or flood, threats to organization 101's security such as by fraud, threats to organization 101's business operations such as by equipment failure, or any other threats to organization 101 or its resources. By enabling organization 101 to define and catalogue its risk/audit universe (e.g., to create a list of risks 128) and to map risks 128 to mitigating controls 122, system 101 may enable organization 101 to organize and implement controls 122, for example, to effectively prevent risks 128 from becoming a reality.

In particular embodiments, organization 101 may internally identify, document, and assign mitigating controls 122 to risks 128 using system 120 to ensure that organization 101 is safe-guarded against risks 128. For example, risk department 101d may be responsible for identifying risks 128 and putting controls 122 in place to mitigate risks 128 (e.g., to ensure that risks 128 do not turn into real events). In particular embodiments, system 120 may allow risk department 101d to generate a list of all its identified risks 128 and to decide whether or not risks 128 are being properly controlled by controls 122. Thus, system 120 may provide a risk manager (e.g., CRO 66) with the ability to view a portfolio of the risks 128 being managed by organization 101 and the supporting controls 122 designed to mitigate risks 128. The risk manager may then create one or more programs 140 or projects 142 to further mitigate risks 128 that are not being effectively managed.

In particular embodiments, risks 128 may be hierarchically arranged. Accordingly, each risk 128 may have one or more child risks 128 directed to a particular threat within the larger risk 128. Thus, a parent risk 128 may have numerous child risks 128. For instance, organization 101 may implement a program 140 to address a broad parent risk 128 and may use projects 142 within that program 128 to address various child risks 128. In particular embodiments, there may be no limit on the number of levels in the hierarchy of risks 128. Thus, the hierarchy of risks 128 may enable organization 101 to manage risks 128 broadly or granularly. Consequently, system 120 may enable organization 101 to manage risks 128 at a granular level or to evaluate an aggregation of risks 128 at a higher level, for example, to determine whether there is a high level trend of deficiencies in organization 101 that needs to be addressed.

To assist organization 101 in managing risks 128, each risk 128 may include a “risk description” field that may provide a textual description of risk 128, a “risk ID” field that includes a unique alphanumeric identifier that identifies each risk 128, a “risk owner” field that may identify the resource (e.g., a member of organization 101) responsible for managing risk 128, a “risk status” field that may identify whether risk 128 is open (e.g., unaddressed) or closed (e.g., addressed), a “risk type” field that may identify a category of risks 128, a “loss category” field that may identify one or more business areas that may be affected by risk 128, an “impact date” field that may indicate a date when a problem may arise from risk 128, a “resolution date” field that may indicate a date when a resolution will be available for risk 128, and a “controls” field that may link mitigating controls 122 to risk 128.

In particular embodiments, system 120 may enable a user to generate quantitative data regarding risks 128 in order to develop an appropriate or optimal strategy to mitigate risks 128. For example, in particular embodiments, system 120 may enable a user to enter one or more risk values related to a particular risk 128 which system 120 may use to estimate a level of seriousness of risk 128. In particular embodiments, the factors used to rank risks 128 may vary according to departments 101a-f (e.g., each of department 101a-f may define its own risk factors). This may enable different departments within organization 101 to score and prioritize risks 128 based on their own criteria. For example, system 120 could prompt a user to identify a risk type for a particular risk 128 (e.g., financial risk, security risk, etc.). Based on the risk type, system 120 could then provide customized risk factors (e.g., how many controls 122 are in place to mitigate the risk 128?, what is the degree of harm presented by the risk 128?, etc.) tailored to risk type.

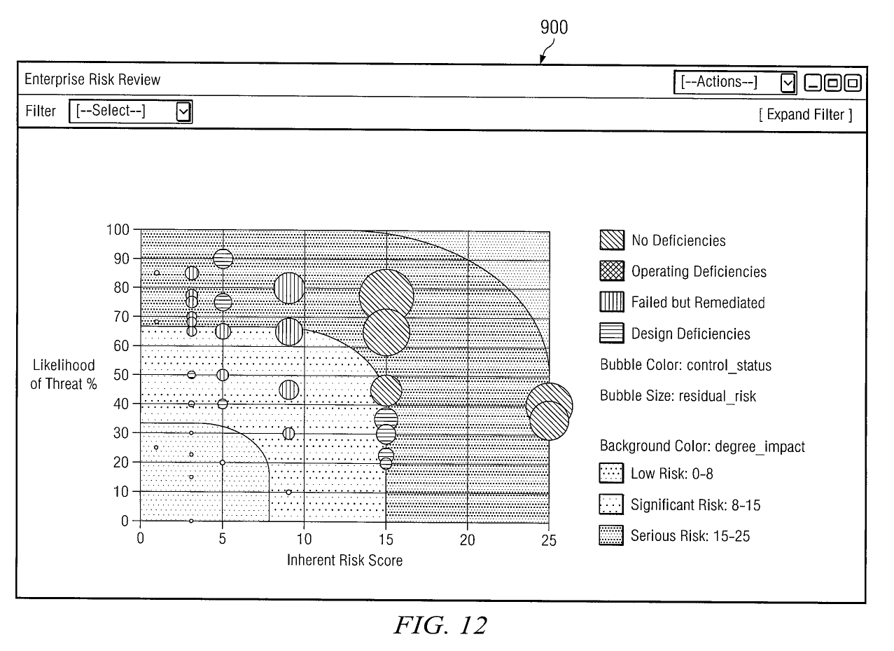

In particular embodiments, system 120 may calculate two risk values using the above data: inherent risk and residual risk. Inherent risk may identify a degree of danger that is inherent in risk 128 while residual risk may identify a degree of danger that remains after controls 122 have been implemented to mitigate risk 128. These risk values may provide risk department 101d with a quantifiable ranking of risk (e.g., a value between 0 and 25) for each risk 128. Such data could also be displayed graphically (See FIG. 12). For example, system 120 may provide a graph depicting a number of risks 128 wherein the color of each risk 128 identifies a level of inherent risk (e.g., White—No data, Green—low inherent risk (score 0-8), Yellow—significant inherent risk (score 8-15), and Red—serious inherent risk (score 15-25)) and/or residual risk (e.g., White—No data, Green—low inherent risk (score 0-8), Yellow—significant inherent risk (score 8-16), and Red—serious inherent risk (score 16-25)).

System 120 may further enable organization 101 to comply with one or more requirements 126 (e.g., regulatory requirements 126) by enabling organization 101 to effectively manage and implement controls 122 to comply with requirements 126. Requirement 126 may be any compliance need imposed on organization 101. For example, a government regulation (e.g., HIPAA) may impose numerous requirements 126 on organization 101. In particular embodiments, system 120 may allow compliance department 101b to generate a list of all requirements 126 facing organization 101 and to determine whether or not requirements 126 are being properly complied with using controls 122. Thus, system 120 may provide a risk manager (e.g., CRO 66) with the ability to view a portfolio of the requirements 126 faced by organization 101 and the supporting controls 122 designed to comply with requirements 126. If organization is not effectively complying with a requirement 126, the user may create one or more projects 142 to institute further controls 122 to comply with the requirement. By enabling organization 101 to catalogue its risk/audit universe (e.g., to create a list of regulatory requirements 126) and to map requirements 126 to complying controls 122, system 101 may enable organization 101 to organize and implement controls 122, for example, to effectively comply with regulations in a manner that may be especially beneficial for audits.

In particular embodiments, each requirement 126 may be broken down into more granular components referred to as specific requirements 132. Specific requirements 132 are directed to a particular purpose within a larger requirement 126 (e.g., specific requirements 132 may be hierarchically arranged beneath requirements 126). For example, a specific requirement 132 may represent a section, subsection, or paragraph of a requirement 126 (e.g., of a statute) that imposes an obligation (e.g., a statutory obligation) on organization 101. If a requirement 126 is too general to be satisfied using a single control 122 (which may often be the case), controls 122 may be mapped to specific requirements 132 within that requirement 126 such that requirement 126 may be satisfied, in aggregate, using the controls 122 mapped to its specific requirements 132. Thus, system 120 may provide a compliance manager (e.g., CCO 54) with the ability to view and manage organization 101's compliance efforts at a very granular level or at a very high level.

In particular embodiments, multiple controls 122 may be required to ensure compliance with each specific requirement 132. Accordingly, control objectives 130 may provide an efficient way to associate controls 122 with specific requirements 132. For example, a specific requirement 132 may be so broad as to encompass an entire group of controls 122 contained within a control objective 130. Thus, one or more control objectives 130 may be linked to a specific requirement 132 to comply with specific requirement 132.

To assist organization 101 in managing requirements 126, each requirement 126 may include a “requirement” field that may identify a legislative or organizational source of requirement 126, a “requirement ID” field that may identify requirement 126 with a unique alphanumeric identifier, a “category field” that may link requirement 126 to a particular category 136, and a “Description of Requirement” field that may describe the characteristics of requirement 126 and/or the reason for requirement 126, and a “controls” field that may link mitigating controls 122 to requirement 126. Likewise, each specific requirement 132 may include similar information fields as well as a “requirement association” field that links specific requirement 132 to a larger requirement 126.

Oftentimes, different regulatory sources (e.g., different statutes or regulations) may impose one or more similar requirements 126 on organization 101. As an example and not by way of limitation, both the PCI standards and SoX may impose a requirement 126 for computer security on organization 101. Thus, requirements 126 may often be organized into larger topically-based categories 136 (e.g., banking and finance requirements, energy requirements, data security requirements, general guidance requirements, etc.). In particular embodiments, organization 101 may define categories 136 to suit its own needs and may categorize requirements 126 accordingly. By defining requirements 126 categorically, system 120 may enable organization 101 to identify and comply with overlapping requirements 126 without unnecessary redundancy. Moreover, system 120 may enable organization 101 to view requirements 126 either categorically or in relation to a particular regulatory source from which it stems. For example, a member of IT department 101e may view all of the requirements 126 related to a “Data Security” category 136 by applying a category-based filter to requirements 126, or alternatively, a member of compliance department 101b may view all of the requirements 126 related to a particular regulatory source (e.g., HIPAA) by applying a statutory based filter to requirements 126.

To assist organization 101 in managing categories 136, a category 136 may include for example a “category name” field that may textually identify category 136, a “category ID” field that identifies category 136 with a unique alphanumeric identifier, and a “category description” field that describes the characteristics of category 136.

In particular embodiments, requirements 126 may be imported into system 120 from a third party source that has analyzed numerous regulatory sources and compiled a common set of requirements 126 (and associated specific requirements 132) for each regulatory source. As an example and not by way of limitation, a third party may provide a comprehensive directory of common requirements 126 that are mapped to various regulatory sources and best practices from across the globe. This content may be loaded into system 120 to provide an initial catalog of categories 136, requirements 126, and specific requirements 132 that may be supplemented or modified by organization 101, as needed, to suit its particular needs. Accordingly, once system 120 has been populated with requirements 126 (e.g., by organization 101 or by a third party), organization 101 may internally develop and implement the controls 122 and control objectives 130 needed to comply with requirements 126 using system 120. As an example and not by way of limitation, such a directory of requirements 126 could be the “Unified Compliance Framework” provided by Network Frontiers, LLC.

Information may be automatically entered into system 120 using an Extensible Markup Language “XML” Open Gateway “XOG” that may enable external systems (e.g., external software applications) to import and export relevant information from and to system 120. For example the XOG may support both XML and “Web Service Definition Language “WSDL” integration methods. The XOG may be used to initially populate system 120 with content and/or support on-going data feeds and data synchronization with external systems.

For example, cost data, test data and other applicable information regarding controls 122 may be imported into system 120 from external systems through the XOG. Moreover, system 120 may include one or more agents (e.g., software agents) that may automatically perform tests on certain computer-based controls 122 and may automatically update system 120 with the current test results using the XOG. Likewise, one or more external systems may be configured to automatically gather and feed relevant data (e.g., control test results) into system 120 as such data becomes available. Such functionality may provide continuous controls monitoring of organization 101's controls 122.

In particular embodiments, system 120 may further enable a user to map controls 122 directly to organization 101's assets 150. Each asset 150 may be identified within system 120, for example, by name and may by grouped together with like assets into one or more asset classes. In particular embodiments, a user may individually link controls 122 to a single asset 150 or may link a group of controls 122 to an entire class of assets 150. A baseline standard 138 may provide the user with a mechanism for linking a group of controls 122 to a class of assets 150. More particularly a baseline standard 138 may be a template of controls 122 to be uniformly applied to a class of assets 150.

When baseline standards 138 are applied to assets 150, system 120 may automatically create a new instance of controls 122 for each asset 150 covered by baseline standard 138. Additionally, baseline standard 138 may automatically create a new instance of controls 122 for each new asset 150 brought online by organization 101. Baseline standards 138 may thus lessen the administrative burden of managing GRC activities as new assets 150 are introduced into organization 101.

To assist organization 101 in managing baseline standards 138, each baseline standard 138 may include a “Baseline Standard Name” field that may textually identify baseline standard 138, a “Baseline Standard ID” field that may identify each baseline standard 138 with a unique alphanumeric string, and a “Controls” field that may be used to identify each of the controls 122 included in baseline standard 138.

In particular embodiments, users of system 120 may access system 120 through a user account which may limit the user's rights in system 120 based on the user's role within organization 101. For example, corporate officers (e.g., CFO 52, CCO 54, etc.) may have the right to modify or delete information in system 120 while lower level employees may only have the right to view information in system 120. Thus, system 120 may use role-based security functionality to limit access to content within system 120 or to limit other features of system 120 (e.g., the ability to create programs 14 or projects 142) by role. System 120 may authenticate a user using, for example, a Lightweight Directory Access Protocol “LDAP”-based directory services (e.g., ACTIVE DIRECTORY by MICROSOFT). In particular embodiments, system 120 may support single sign-on technology and may easily integrate into organization 101's other applications (e.g., Human Resource “HR” applications).

Users of System 120 may view and manage the information in system 120 using, for example, one or more dashboards (e.g., user interface screens on output device 116) that may organize and present the information in system 120 in a user-friendly way. For example, dashboards may enable a user to view up-to-date details on controls 122, test results of controls 122, enterprise risks 128, control objectives 130, business objectives 124, baseline standards 138, requirements 126, assets 150, and performance trends.

As an example, system 120 may include a “Regulatory Controls” dashboard that may enable a user of system 120 to view and manage organization 101's compliance activities related to particular government regulations (e.g., requirements 126), or other regulatory sources. The Regulatory Controls dashboard may, for example, enable a user to view a comprehensive list of requirements 126 as well as the controls 122 that organization 101 has in place to comply with requirements 126 and the status of each of controls 122 (e.g., whether or not controls 122 have been successfully tested or implemented).

As an additional example and not by way of limitation, system 120 may include a “Performance Trends” dashboard that may enable a user of system 120 to view control test trends for controls 122 (e.g., whether controls 122 have been failing or passing the control tests). This dashboard may show metrics about test results and comparisons between controls 122.

As an additional example and not by way of limitation, system 120 may include a “Enterprise Risk” dashboard that may enable a user of system 120 to view the risks 128 that face organization 101 (e.g., for specific risk events) and how well controls 122 are mitigating risks 128.

As an additional example and not by way of limitation, system 120 may include a “Control Status” dashboard that may enable a user of system 120 to view control-centric views of assets 150 and risks 128.

As an additional example and not by way of limitation, system 120 may include a “Test Results” dashboard that may enable a user of system 120 to view metrics for test activities and issues 144 related to controls 122, as well a priority and percentage completion data related to such test activities.

In particular embodiments, system 120 may provide a user with a project and portfolio management structure that may enable the user to effectively manage programs 140 and projects 142 associated with implementation, testing, and remediation of controls 122. For example, system 120 may enable organization 101 to initiate and manage projects 142 related to implementing and testing controls 122 to comply with requirements 126, to achieve business objectives 124 and/or to mitigate risks 128.

For example, organization 101 may implement system 120 to manage its GRC activities as described in the following example situation. Organization 101 may be a financial institution having hundreds of offices across the globe that provides banking services and activities. Organization 100 may have a risk management department 101d, a compliance department 101b, and an audit department 101f. Organization 101 may use system 120, for example, to consolidate its controls 122, to standardize its testing procedures for controls 122, and to schedule and generate reports related to controls 122 for auditing or business purposes.

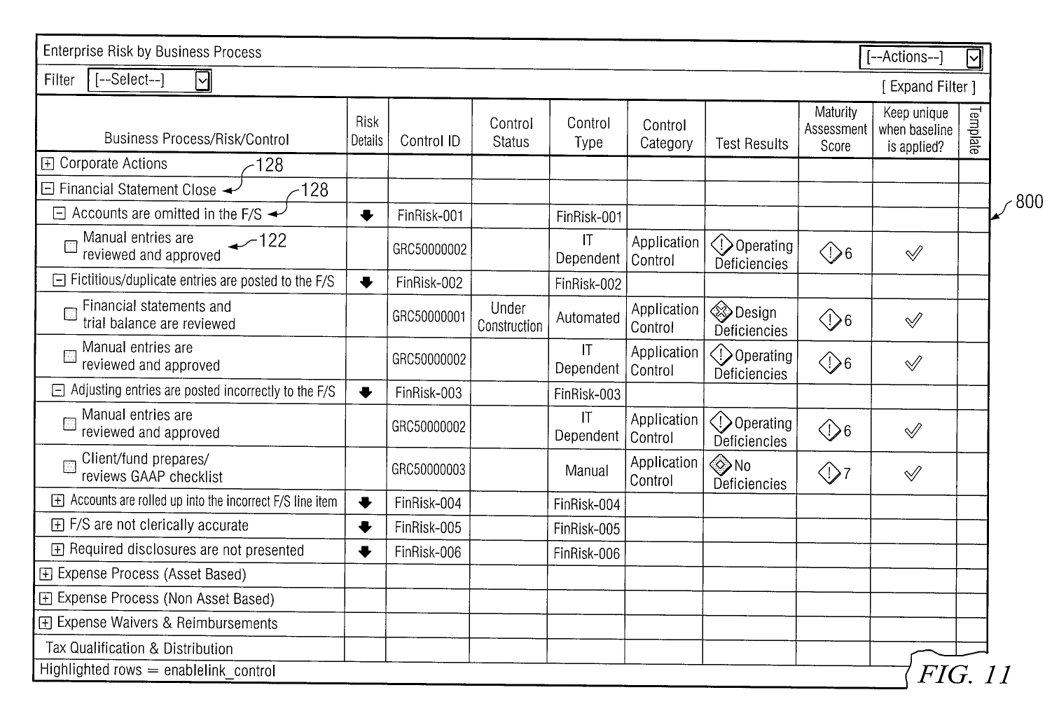

In particular embodiments, system 120 may enable organization 101 to identify and eliminate redundant controls 122 and to normalize controls 122 throughout its entire infrastructure. To begin using system 120, risk management department 101d may identify risks 128 that may prevent organization 101 from meeting its defined objectives. As risk management department 101d identifies new risks 128 and records them in system 120, additional information may be gathered about each risk 128, including whether any mitigating controls 122 already exist to reduce the inherent risk of risk 128 to an acceptable level. Additionally, risk management department 101d may implement new controls 122 to mitigate risks 128. Risk management department 101d may then use dashboards and portlets to determine how effectively controls 122 are functioning across organization 101 to reduce risks 128. For example, Portlet 800 (see FIG. 11) may display a list of risks 128 and the controls 128 that are in place to mitigate risks 128. A user may use portlet 800, for example to identify and eliminate any duplicate or overlapping controls 122. Additionally, portlet 800 may display test results for each of control 122, enabling risk management department 101d to see the current functional status of controls 122 and to determine whether controls 122 are effectively reducing risks 128 to an acceptable residual level.

Organization 101's compliance management department 101b may be tasked with ensuring that organization 101's operations are compliant with all applicable legislative mandates and regulatory requirements 126. Like risks 128, requirements 126 may be stored in system 120. As new legislative requirements are identified, they may be added to system 120. Compliance management department 101b may tie existing controls 120 and control objectives 130 to requirements 126. In the event that Organization 101 does not have sufficient controls 122 in place to satisfy requirements 126, compliance management 101b department may initiate a project 142 to implement additional controls 122 to satisfy these needs using the project management functionality of system 120 (e.g., to identify and assign various tasks related to implementing, testing, and maintaining new controls 122). These projects 142 may further be rolled up into program 140 that may be managed using system 120.

Different departments 101a-f within organization 101 may participate in defining controls 122, and a governance process may be put in place to drive a standard set of control definitions. System 120 may further track the maturity of each control 122 which may be defined by a number of factors including how long a control 122 has been in use, control 122's test history, and the approval process for control 122. Each control 122 may be owned by a particular person within organization 101 who may responsible for any information relevant to the effectiveness of control 122 (e.g., including maturity or self assessment scores, test information, etc.).

Control objectives 130 may be developed within different departments 101a-f and may be used to logically group similar controls 122 and to efficiently apply controls 122 to various GRC needs. Controls 122 may further be categorized according to a number of different criteria including, for example, maturity.

Organization 101 may have spent several months analyzing its risks 128, business objectives 124, and requirements 126 in an effort to determine which controls 122 need to be in place to effectively govern its various classes of assets 150. For example, during this process, compliance management department 101b may have identified a standard set of controls 122 that need to be implemented every time a new PCI server (e.g., asset 150) is brought online in organization 101. Likewise, compliance management 101b department may have developed similar lists of controls 122 to be applied to non-PCI-related assets 150 (e.g., shared service applications, external partner applications, etc.). Because the control requirements for some assets 150 may vary due to differences in international regulations, more complex lists that reflect the differences need to be maintained and managed. To effectively organize and manage asset-related controls 122, organization 101 may create a set of baseline standards 138 that group such controls together and may be used to uniformly apply such controls to various classes assets 150. Organization 101 may also use portlets and dashboards to help identify redundant compliance activities and performance trends across organization 101.

For example, compliance management 101b may have worked in conjunction with risk management department 101d and audit department 101f to develop a series of baseline standards 138 that ensure the appropriate controls 122 are governing its applications and assets 150. As new assets 150 or applications are brought online into production, such assets 150 may be assigned to one or more baseline standards 138 using, for example, numeric asset identifiers which system 120 use to identify and manage each asset 150. System 120 may use baseline standards 138 to automatically create and associate controls 122 with each new asset 150 based on the template of controls provided by baseline standard 138.

Baseline standards 138 may help organization 101 to create repeatable processes and minimize the administrative overhead associated with compliance management. Without baseline standards 138, organization 101 may have struggled to determine which controls 122 to apply to its assets 150. With no vehicle available to map controls 122, requirements 126, risks 128, and business objectives 124 to its assets 150, organization 101 may have over-controlled some assets 150, while completely ignoring others. Using baseline standards 138, organization 101 may establish a simple process to determine which controls 122 should apply to its assets 150 to ensure that the correct controls 122 are implemented.

As new risks 128 and requirements 126 are identified by organization 101, organization 101 may create new additional controls 122, which were not previously required. Whenever this occurs, compliance management 101b department, in conjunction with audit department 101f and risk management department 101d, may update baseline standards 138 to reflect new control requirements. As new controls 122 are added to baseline standards 138, system 120 may automatically determine the impact on the assets 150 governed by such baseline standards 138 and may create new controls 122 or new associations to existing controls 122 to adaptively manage assets 150 in light of the changing needs of organization 101.

Controls 122 may need to be tested regularly to ensure their ongoing effectiveness and to demonstrate compliance with regulatory guidelines (e.g., requirements 126). The test activities may be defined as projects 142 within the project management functionality of system 120. Thus, organization 101 may use system 120 to put test-related projects 142 into operation. For example, the compliance department 101b may use system 120 to issue work orders to certain of its members identifying particular controls 122 to be tested as well as describing a test plan 134 for testing such controls 122. Information about each test may be recorded for each control 122 and any evidence associated with the tests may, for example, be checked into the document management department for safekeeping. Alternatively, information about each test may be electronically attached to each control 122.

Any exceptions or deficiencies that occur during the testing of controls 122 may be recorded as issues 144 and logged as projects 142 for remediation that may further be managed using system 120. Furthermore, if a particular control 122 related to a government regulation fails a test, it may be noted with reference to organization 101's compliance efforts directed towards that regulation. For example, if the failed control 122 was related to SoX, the failure may be logged against organization 101's SoX compliance program 140 and a member of organization 101 tasked with ensuring SoX compliance may be notified accordingly.

By providing organization 101 with a high level view of its various business objectives 124, risks 128, and requirements 126, system 120 may enable organization 101 to implement and manage controls 122 from the top down. For example, compliance department 101b may implement a program 140 to bring organization 101 into compliance with a particular government regulation (e.g., SoX) using a top down approach. More particularly, compliance department 101b may use system 120 to identify the high level requirements 126 imposed upon organization 101 by SoX. Once compliance department 101b has identified requirements 126 (and specific requirements 132, if applicable) compliance department 101b may begin to develop control objectives 130 to comply with the various requirements 126 of SoX. Within each of these control objectives 130, compliance department 101b may develop further controls 122 at a more granular level. Compliance department 101b may then implement various projects 142 to implement, test, and maintain these control objectives 130 and controls 122 within organization 101 in order to comply with requirements 126, and to a larger degree, SoX. Thus, system 120 may provide robust top down functionality that may enable organization 101 to develop its controls infrastructure from the top down using high level requirements 126, business objectives 124, and/or risks 128 as a guide to direct its control development activities.

One benefit of the top-down approach is that organization 101 may first define a goal or need that is important to it, and may then identify one or more controls 122 that need to be implemented to achieve the defined goal. As one example, this approach may allow organization 101 to define a business objective 124 as well as identify various risks 128 that may interfere with organization 101's progress towards meeting that business objective 124. As a result, organization 101 may implement various controls 122 to mitigate these risks 128, thereby mitigating the interference with the business objective 124. This aspect of the top down approach may focus organization 101 on implementing the proper controls 122 to achieve its goals. However, a purely top down approach may be overwhelmingly manual in nature, sometimes requiring organization 101 to gather and input volumes of data into its compliance system regarding each of its controls 122. Technologies that adopt a purely top-down approach may be process centric, meaning they may not scale well when organization 101 is faced with a new compliance requirements 126 or when groups within the organization 101 have differing methodologies or processes in place to achieve their goals.

System 120 may also provide organization 101 with bottom up functionality that may enable organization 101 to leverage its existing controls 122 to satisfy various high level requirements 126, business objectives 124, and/or risks 128. For example, risk department 101d may implement a program 140 to identify and categorize all of it existing controls 122 into higher level control objectives 130. Once these control objectives 130 have been developed, risk department 101d may analyze these control objectives 130 to identify areas of risk 128 that are not being effectively managed by organization 101, and may implement various projects 142 to mitigate the identified risks 128. Thus, system 120 may provide robust bottom up functionality that may enable organization 101 to identify high level requirements 126, business objectives 124, and/or risks 128 using its existing lower level controls 122 as a guide to identify various high level needs of organization 101 that are not being effectively managed by its current controls.

One goal of the bottom-up approach may be to quickly analyze existing operations (e.g., controls 122) and determine if potential compliance issues exist. Technologies employing a bottom up approach may have agents or other mechanisms that interact with lower-level control systems to extract and massage existing compliance related data for reporting. One advantage of the bottom up approach is that it may enable organization 101 to automate the process of gathering and reporting of controls data. However, technologies employing a purely bottom up approach may, like an Intrusion Detection or Vulnerability Management systems, inaccurately report the severity of issues and deficiencies across technologies because bottom up controls 122 may not take into account manual or “compensating” controls. Accordingly, particular embodiments of the present disclosure may combine elements of the top-down and bottom-up approaches to governance, risk, and compliance management.

One of ordinary skill in the art will appreciate that the above-described example was presented for the sake of explanatory simplicity and will further appreciate that the features or operability of system 120 are in no way limited to the example embodiments presented above.

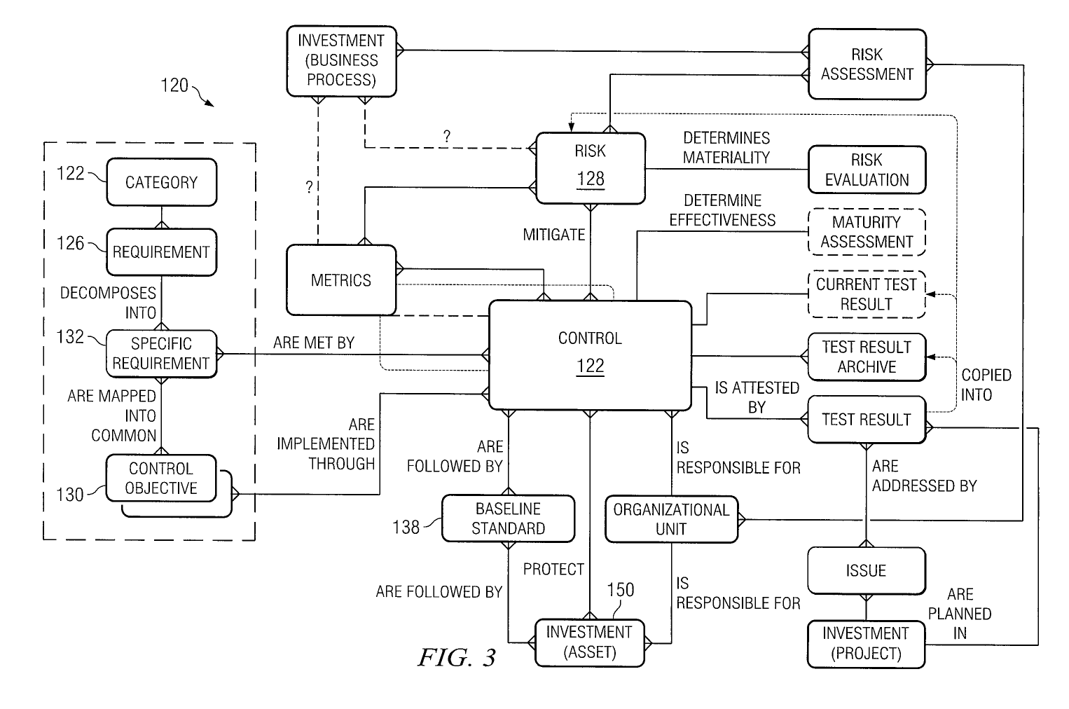

FIG. 3 illustrates a more detailed view of particular example objects and example relationships that may be included in system 120. For instance, control 122 may satisfy a number of different needs of organization 101. More particularly, organization 101 may use controls 122 to comply with a federal regulation, the requirements 126 of which, may be decomposed into specific requirements 132 that may be met by controls 122 and mapped into common control objectives 130 that may be implemented using controls 122. Furthermore, requirements 126 may be categorized into common categories 122 for easy high level reference.

Controls 122 may further be used to mitigate risks 128. For instance an organizational unit in organization 101 may perform a risk assessment to determine the risks 128 to organization 101 and may use system 101 to determine the materiality of risks 128 by performing a risk evaluation that provides various metrics about risks 128 such as, for example, estimated levels of inherent and residual risk. These metrics may then be used to effectively manage controls 122 to mitigate risks 128.

Controls 122 may also be used to protect assets 150 (e.g., investments). For example an organizational unit that is responsible for assets 150 may establish one or more baseline standards 138 that define a standard set of controls 122 that are to be followed by a particular type (e.g., class) of assets 150.

Organization 101 may determine the effectiveness of controls 122 by performing a maturity assessment. Furthermore, organization 101 may test its controls, for example, using a test plan 134, the results of which may be stored in a test results archive. As new or more current test results are obtained, they may be copied into the test results archive which may be used to attest to the effectiveness of controls 122 (e.g., for auditing purposes). Test results may also be used to identify issues 144 that may then be addressed as projects 142 using system 120.

One of ordinary skill in the art will appreciate that the above-described relationships and objects in system 120 were presented for the sake of explanatory purposes and are not limitive of the objects or relationships between objects in system 120.

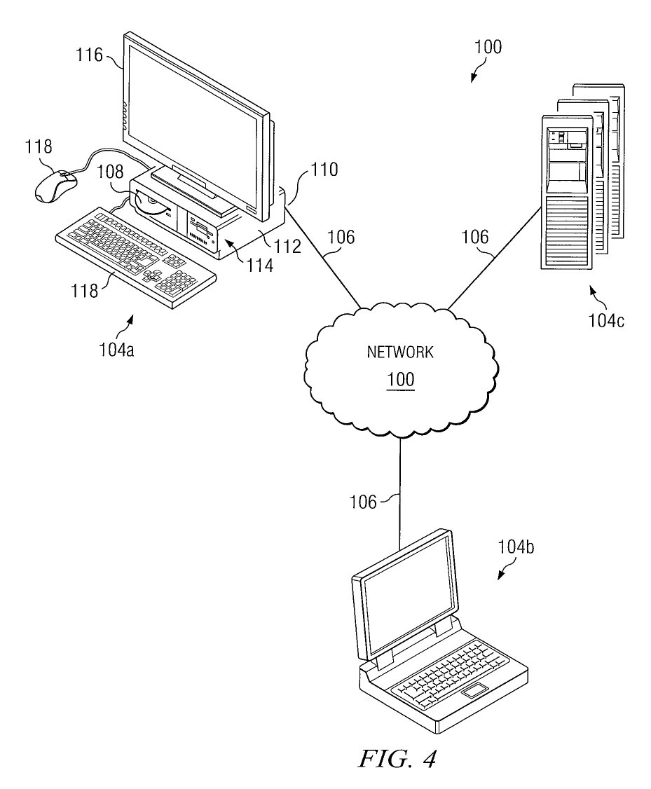

FIG. 4 illustrates an example network 100, having one or more components which may implement system 120 to provide GRC management services to organization 101. In particular embodiments, network 100 may include one or more local area networks (LAN), one or more wireless LANs (WLAN), one or more wide area networks (WAN), one or more metropolitan area networks (MAN), a portion of the Internet, or another form of network or a combination of two or more such networks. The present disclosure contemplates any suitable network 100 or combination of networks 100. In particular embodiments, components of network 100 are distributed across multiple cities or geographical regions. In particular embodiments, network 100 may be represented by multiple distinct, but interconnected networks that share components or distinctly contain similar components. Distinction between networks and network components may be defined, for example, by geographic location, individual ownership, differing network architectures, or other distinction.

Example components of network 100 include one or more clients 104 coupled to network 100 via one or more links 106. In particular embodiments, links 106 may each include one or more wireline, wireless, or optical links. In particular embodiments, one or more links 106 each include a LAN, a WLAN, a WAN, a MAN, a portion of the Internet, or another link 16 or a combination of two or more such links 106. Each of the components coupled to network 100 communicate with each other via use of network 100.

Each of clients 104 may include any component of hardware or software or combination of two or more such components operable to provide data management services. As an example and not by way of limitation, one or more clients 104 may be a personal computer (104a), a laptop (104b), a plurality of servers (104c), a personal digital assistant (PDA), or another computing device that may include an interface 110, one or more processors 114, and a memory 112 comprising or capable of receiving program instructions recorded on a tangible computer readable media 108 (e.g., a cd-rom, a flash drive, a floppy disk, etc.) that when executed by processors 114 perform some or all of the functionality described herein. In particular embodiments, organization 101 may own and/or operate a number of clients 104 and/or may employ the services of one or more third parties owning other clients 104 to provide itself with GRC services according to particular embodiments of the present disclosure.

Processor 114 may be a microprocessor, controller, or any other suitable computing device, resource, or combination of hardware, software and/or encoded logic operable to provide, either alone or in conjunction with other components of network 100 (e.g., memory 112) computer-based functionality of particular embodiments of the present disclosure. Accordingly, memory 112 may be any form of volatile or non-volatile memory including, without limitation, magnetic media, optical media, random access memory (RAM), read-only memory (ROM), removable media, or any other suitable local or remote memory component and interface 110 may comprise any hardware, software, or encoded logic operable to send and receive information to and from other components of network 100 such as other clients 114. Such functionality may include providing various features discussed herein to a user via suitable output device(s) 116 (e.g., a monitor or printer) and/or receiving input from a user via suitable input device(s) 118 (e.g., a keyboard or a mouse). In particular embodiments, all of the functionality and features herein may reside and be performed on a single client 104, or may reside and be performed in a distributed fashion amongst multiple clients 104 across network 100. Particular features described herein may be implemented, for example, in the form of a database computer program, portions or which may be web-based, operating on any suitable client(s) 104 in network 100 operable to provide GRC management services to organization 101.

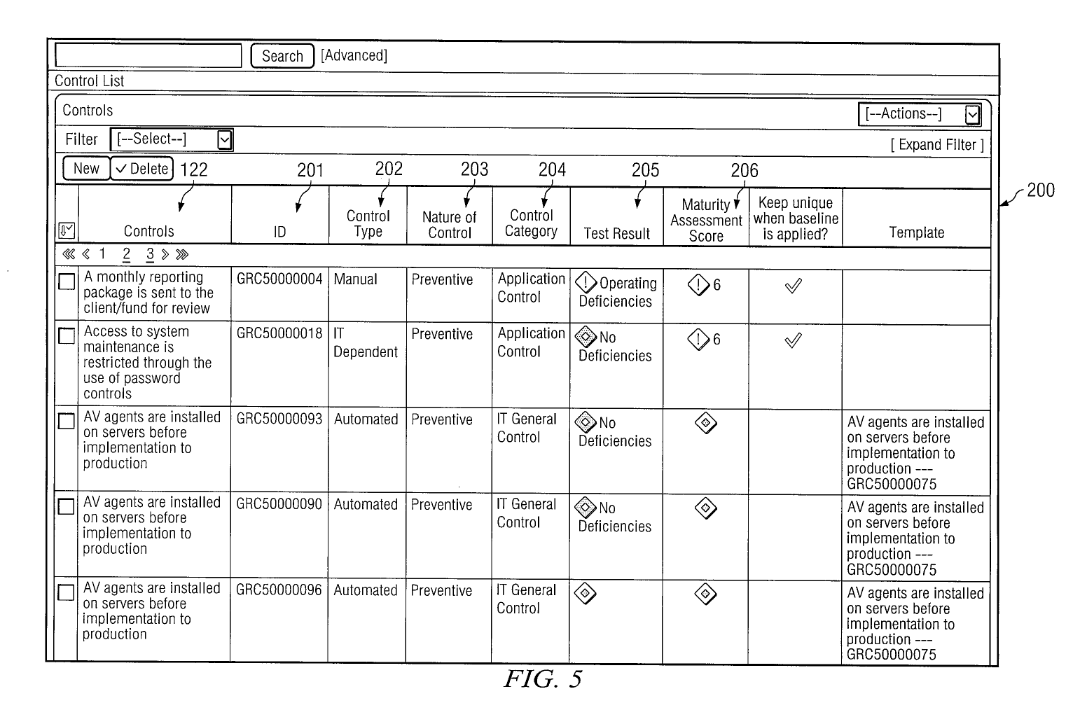

FIGS. 5-14, 16-19, and 21-24 illustrate example portlets through which a user may view and manage the various objects in system 120. One of ordinary skill in the art will appreciate that the following portlets are presented for the sake of explanatory clarification and are in no way limitive of the features of system 120. In particular embodiments, a user of system 120 may customize and create enhancements to the environment of system 120. For example users of system 120 may modify the particular database tables, object models, object associations, object attributes, screens, workflows, process flows, portlets, processes, and dashboards of system 120. For example, to suit the specific needs of organization 101, custom fields may be added to each of the objects in system 120, or existing fields associated with each object may be deleted or modified by the user.

FIG. 5 illustrates an example portlet 200 of system 120 that displays a list of controls 122. Portlet 200 may enable a user to view various controls 122 by sorting, filtering, or searching controls 122 using various criteria associated with controls 122 (e.g., information in the control fields). Additionally, portlet 200 illustrates various data regarding each control 122 including a control ID 201, a control type 202, a control nature 203, a control category 204, a control test result 205, a control maturity score 206, etc. Moreover, particular fields of data regarding controls 122 (e.g., test results 205 and maturity scores 206) may be presented using graphical indicators to present the corresponding information to a user in a user-friendly and readily-understandable way. One of ordinary skill in the art will appreciate that portlet 200 was presented for the sake of explanatory clarification and will further appreciate that the present disclosure contemplates presenting any suitable information regarding controls 122 in any suitable layout in portlet 200.

FIG. 6 illustrates an example portlet 300 of system 120 that displays a hierarchical view of control objective 130 and controls 122. Using portlet 300, a user of system 120 may view each control 122 contained within a specific control objective 130, and thus may identify and eliminate duplicative, inefficient, or needless controls 122. A user may further view the hierarchical relationships between parent and children control objectives 130. One of ordinary skill in the art will appreciate that portlet 300 was presented for the sake of explanatory clarification and will further appreciate that the present disclosure contemplates using any suitable layout and method to display the relationships between controls 122 and control objectives 130.

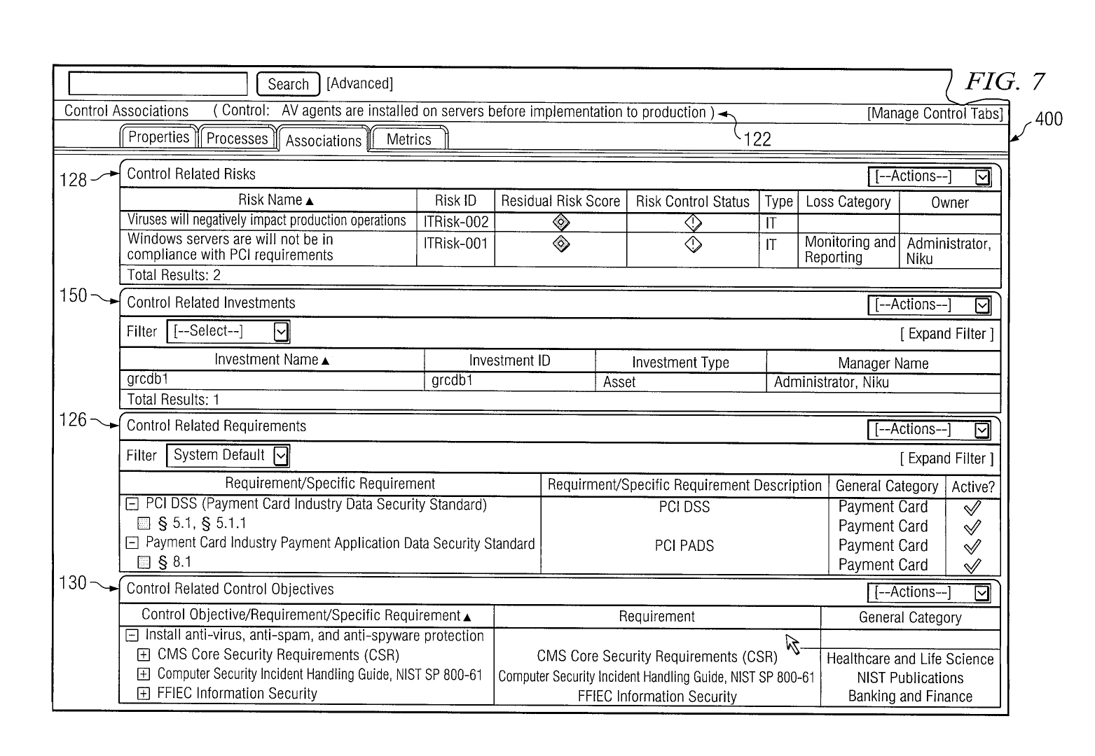

FIG. 7 illustrates an example portlet 400 of system 120 that displays example associations of a control 122. For example, control 122 may be associated with various risks 128, assets 150, requirements 126, and control objectives 130. Moreover, portlet 400 may illustrate various data regarding each associated object. Using portlet 400, a user of system 120 may determine, for example, whether a particular control 122 may be eliminated in light of its associations. One of ordinary skill in the art will appreciate that portlet 400 was presented for the sake of explanatory clarification and will further appreciate that the present disclosure contemplates presenting any suitable relationships between controls 122 and other objects in system 120 in portlet 400.

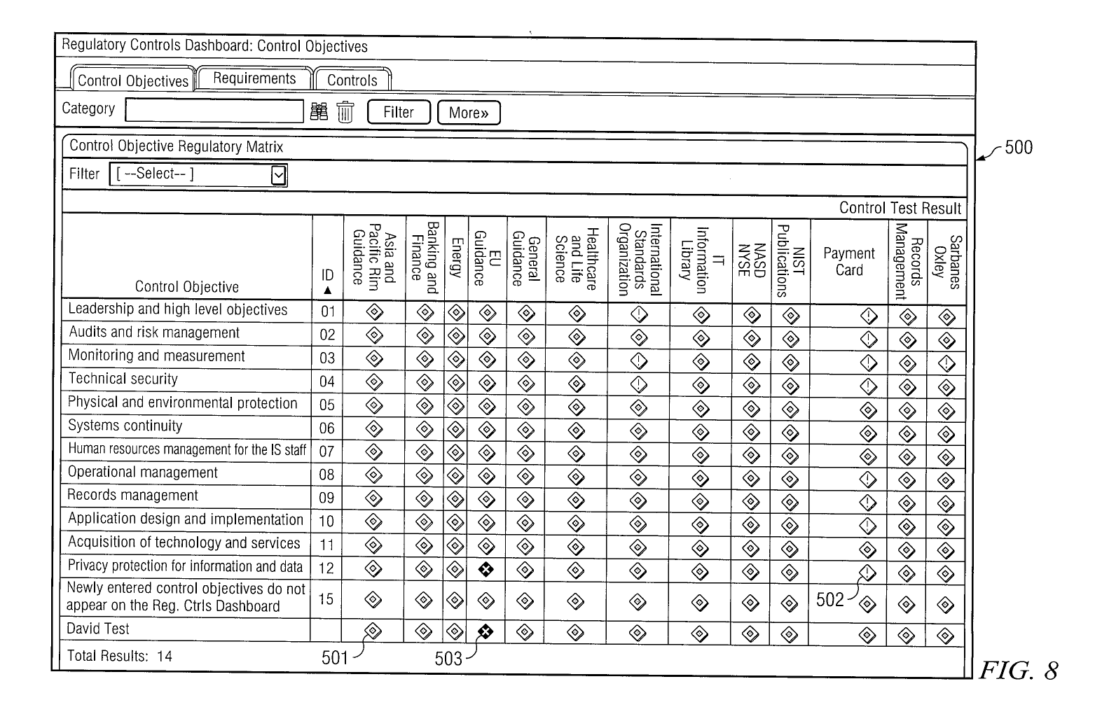

FIG. 8 illustrates an example portlet 500 of system 120 that displays example associations between control objectives 130 and various statutory and regulatory sources. More particularly, portlet 500 includes a tabular display that graphically indicates which control objectives 130 are being used to comply with the various statutory and regulatory sources. For example, a “not applicable” symbol 501 may indicate that a control objective 130 is not applicable to a particular statutory or regulatory source. A “warning” symbol 502 may indicate that a particular control objective 130 is being applied to a particular statutory or regulatory source, but that one or more deficiencies with the control objective 130 may need to be addressed (e.g., one or more controls 122 within the control objective 130 may need to be tested). A “failed” symbol 503 may indicate that a particular control objective 130 is being applied to a particular statutory or regulatory source, but that the control objective is failing to satisfy the requirements 126 of the particular statutory or regulatory source (e.g., one or more controls 122 within the control objective 130 may have failed a test). One of ordinary skill in the art will appreciate that portlet 500 was presented for the sake of explanatory clarification and will further appreciate that the present disclosure contemplates using any suitable layout and method to display the relationships between control objectives 130 and various regulatory and statutory sources.

FIG. 9 illustrates an example graphical display portlet 600 that graphically depicts various information about controls 122 in a graphical form. More particularly, each bubble may represent a particular control 122. In particular embodiments, a color of a bubble may indicate a test status of the control 122 (e.g., not tested, tested and passed, tested and failed, etc.) and a size of the bubble may indicate a maturity score of the associated control 122. In order to view the control 122 represented by a particular bubble, a user may hover the mouse indicator over the bubble to display control-related information. In particular embodiments, a user may filter the controls 122 (e.g., using various information in the control fields or according to various associations), for example, to limit the number of bubbles displayed in portlet 600. One of ordinary skill in the art will appreciate that portlet 600 was presented for the sake of explanatory clarification and will further appreciate that the present disclosure contemplates using any suitable graphical layout to graphically display information regarding controls 122 to a user.

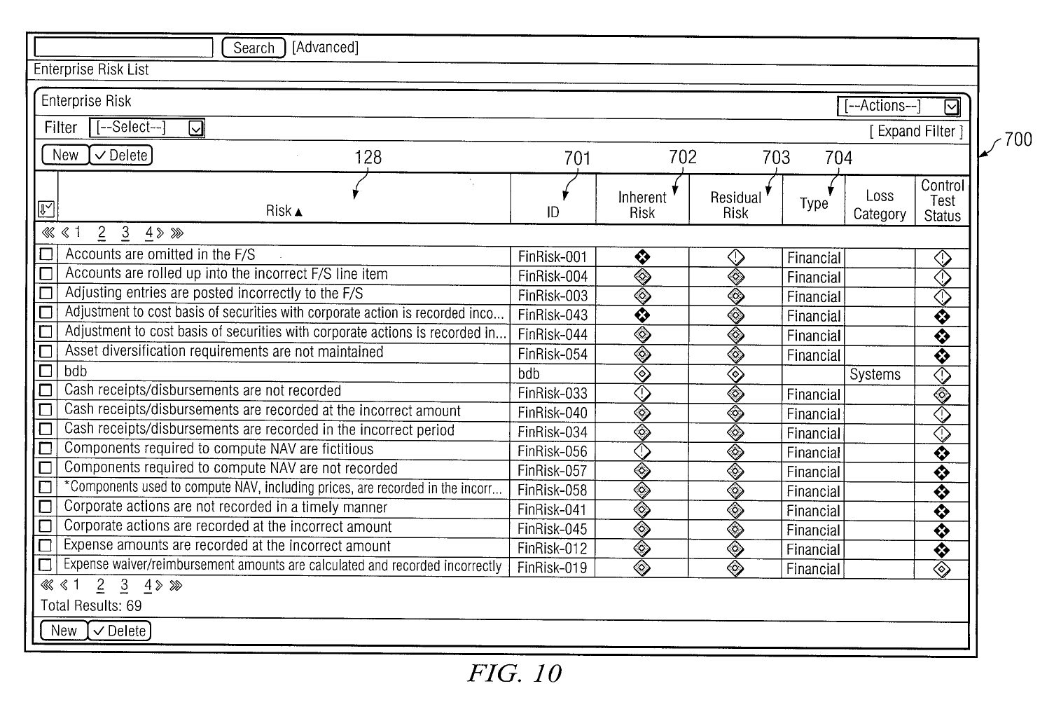

FIG. 10 illustrates an example portlet 700 of system 120 that displays a list of risks 128. Portlet 700 may enable a user to view various risks 128 by sorting, filtering, or searching risks 128 using various criteria associated with risks 128 (e.g., information in the risk fields). Additionally, portlet 700 illustrates various data regarding each risk 128 including a risk ID 701, an inherent risk level 702, a residual risk level 703, a risk type 704, etc. Moreover, particular fields of data regarding risks 128 (e.g., inherent risk level 702 and residual risk level 703) may be presented using graphical indicators to present the corresponding information to a user in a user-friendly and readily-understandable way. One of ordinary skill in the art will appreciate that portlet 700 was presented for the sake of explanatory clarification and will further appreciate that the present disclosure contemplates presenting any suitable information regarding risks 128 in any suitable layout in portlet 700.

FIG. 11 illustrates an example portlet 800 of system 120 that displays a list of risks 128 as well as the controls 122 that are being used to mitigate risks 128. More particularly, risks 128 may be arranged and categorized in a hierarchical fashion such that a user may easily navigate through particular risks 128 by browsing through the various hierarchical levels of risks 128. In particular embodiments, the bottom-most level of the hierarchy may display the controls 122 being used to mitigate risks 128. Portlet 800 may further display various data regarding controls 122 and risks 128 that may enable a user to quickly determine whether controls 122 are functioning properly to mitigate risks 128. One of ordinary skill in the art will appreciate that portlet 800 was presented for the sake of explanatory clarification and will further appreciate that the present disclosure contemplates using any suitable layout and method to display the relationships between controls 122 and risks 128.

FIG. 12 illustrates an example graphical display portlet 900 that graphically depicts various information about risks 122 in a graphical form. In particular embodiments, various characteristics of the graph depicted in portlet 900 may graphically correspond to the quantitative data regarding each risk 128 as described with respect to FIG. 2. In order to view the risk 128 represented by a particular bubble, a user may hover the mouse indicator over the bubble to display risk-related information. In particular embodiments, a user may filter the risks 128 (e.g., using various information in the risk fields or according to various associations), for example, to limit the number of bubbles displayed in portlet 900. One of ordinary skill in the art will appreciate that portlet 900 was presented for the sake of explanatory clarification and will further appreciate that the present disclosure contemplates using any suitable graphical layout to graphically display information regarding risks 128 to a user.

FIG. 13 illustrates an example portlet 1000 of system 120 that displays a hierarchical view of requirements 126 and specific requirements 132. Using portlet 1000, a user of system 120 may view each of the specific requirements 132 contained within a particular requirement 126. In particular embodiments, a specific requirement 132 may be represented in portlet 1000 by a particular legislative section number that identifies the particular section of legislation from which it stems. A user may, for example, view a textual description of each specific requirement 132 by clicking on the section number that represents the specific requirement 132. In particular embodiments, portlet 1000 may also display the particular controls 122 that are being used to comply with each specific requirement 132. One of ordinary skill in the art will appreciate that portlet 1000 was presented for the sake of explanatory clarification and will further appreciate that the present disclosure contemplates using any suitable layout and method to display the relationships between requirements 126 and control objectives 130.

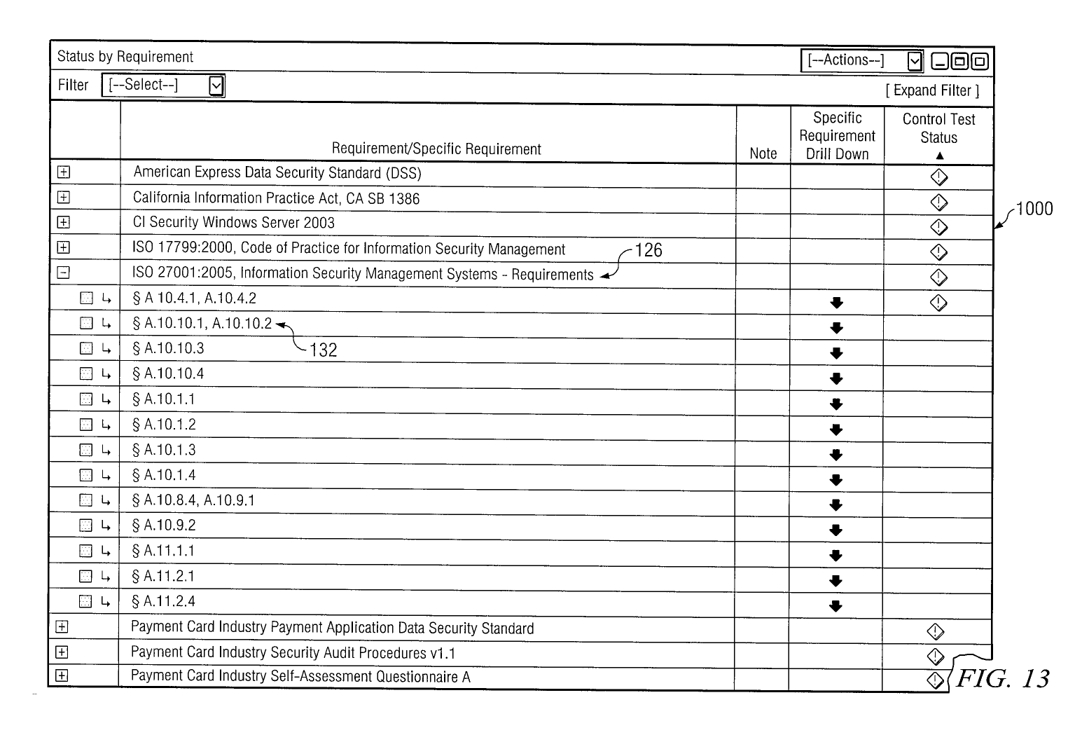

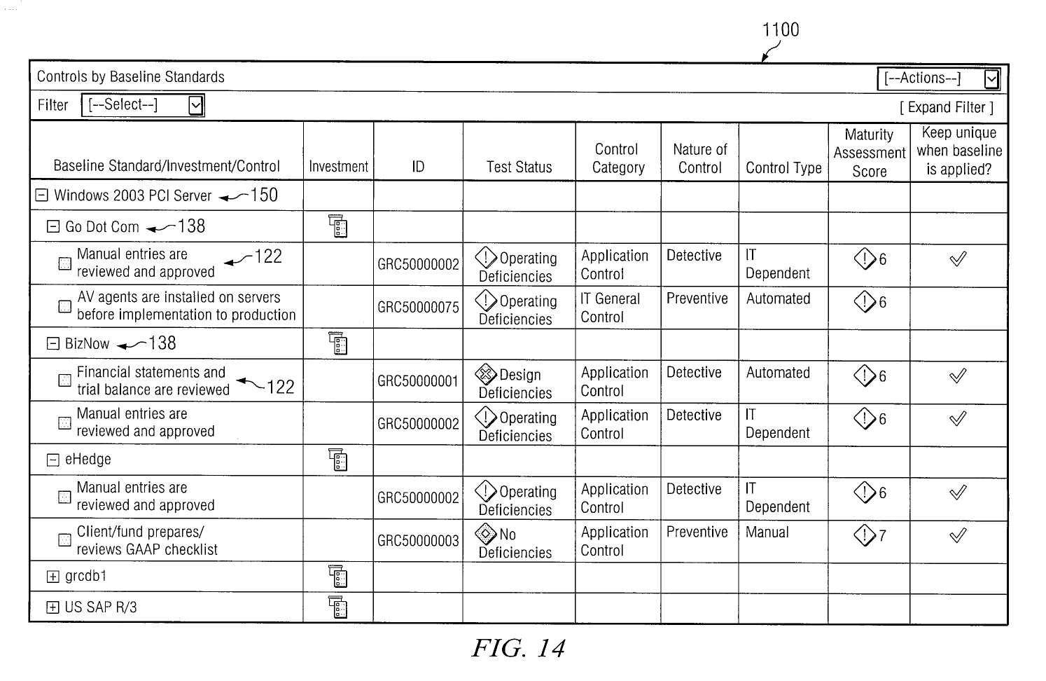

FIG. 14 illustrates an example portlet 1100 of system 120 that displays a list of baseline standards 138 associated with a particular type of asset 150. In particular embodiments, an asset 150 may be associated with multiple baseline standards 138. One of ordinary skill in the art will appreciate that portlet 1100 was presented for the sake of explanatory clarification and will further appreciate that the present disclosure contemplates using any suitable layout and method to display the relationships between assets 150, baseline standards 138, and controls 122.

Using one or more of the features described above, system 120 may enable organization 101 to define its risk/audit universe. For example, organization may use system 120 to define its corporate business objectives 124 (e.g., define the business goals that organization 101 wants to achieve), to document and organize its requirements 126 (e.g., define the regulatory requirements 126 with which organization 101 has to comply), to identify its risks 128 (e.g., define the threats that organization 101 wants to avoid), and to document and organize its controls 122 (e.g., to organize the controls 122 which organization 101 is using to achieve business objectives 124, comply with its requirements 126, and mitigate its risks 128). Secondly, organization 101 may use system 120 to assess and report their GRC activities against their current risk/audit universe. For example, organization 101 may use system 120 to perform business impact analyses or control gap analyses (e.g., to determine the GRC activities that organization 101 should be doing) and to perform risk and control self assessments, control testing, project management, and financial management (e.g., to determine how organization 101 may improve its existing GRC activities).

Furthermore, particular embodiments of system 120 may enable organization 101 to assess, for example, the quality of its control environment (e.g., the number of controls 122 in place), the health of its control environment (e.g., whether the controls 122 are working effectively to satisfy organization 101's internal and external needs), and the cost of its control environment (e.g., the financial impact of implementing or maintaining a control 122). Organization 101 may thus uniformly implement various controls 122 to deal with its GRC needs as well as manage, monitor, and test these controls 122 while tracking the costs associated with implementing and maintaining them using a single system 120.

As described above, organization 101 may use system 120 to manage and implement controls 122 in order to accomplish various goals 123 such as mitigating a risk 128, achieving a business objective 124, or complying with a requirement 126. In particular embodiments, system 120 may further enable organization 101 to track its progress towards accomplishing a particular goal 123 by providing organization 101 with the ability to create one or more metrics 162 which define the relevant criteria needed to monitor organization 101's progress toward achieving goal 123 and one or more key indicators 160 to act as reference points by which organization 101 may gauge its progress toward achieving goal 123 at a particular point in time.

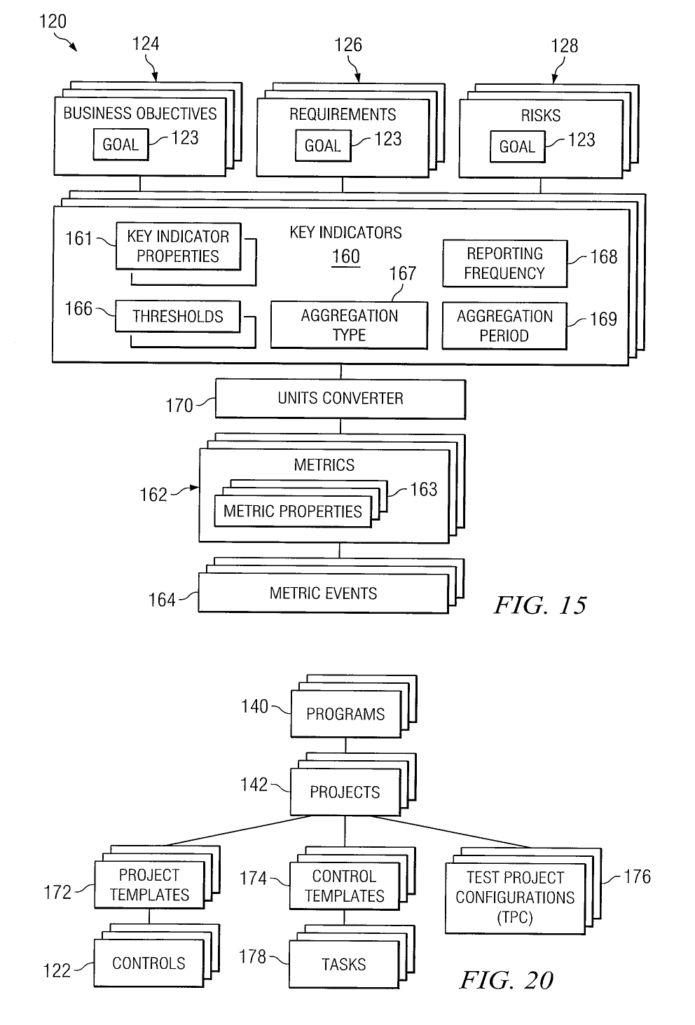

FIG. 15 illustrates an example view of a portion of system 120 which may enable organization 101 to track its progress towards accomplishing a goal 123. For the sake of explanatory convenience, accomplishing a goal 123 may generically refer to mitigating a risk 128, achieving a business objective 124, satisfying a requirement 126, or accomplishing another defined objective of organization 101 outside of these categories.

Once organization 101 has defined goal 123, organization 101 may develop one or more metrics 162 to collect various kinds of data relevant to measuring the accomplishment of goal 123. Organization 101 may further establish one or more key indicators 160 to measure whether the captured data in metrics 162 is in line with organization 101's predefined expectations for accomplishing goal 123. Accordingly, each business objective 124, risk 128, requirement 126 or any other suitable goal 123 may be individually linked to one or more key indicators 160 and one or more metrics 162 to enable organization 101 to quantifiably measure its progress towards accomplishing each of those goals 123.

A metric 162 may be any measurable statistic related to accomplishing a goal 123 of organization 101. Typically, metrics 162 are defined by organization 101 to establish the relevant criteria needed to monitor a goal 123. Accordingly, each goal 123 may be associated with a different set of metrics 162. However, depending upon the nature of the information included in a metric 162, organization 101 may determine that a single metric 162 is applicable to multiple goals 123 and therefore may map such a metric 162 to multiple goals 123 in a one to many relationship. In any case, the criteria needed to monitor organization 101's progress toward achieving a goal 123 may be defined by an individualized set of metrics 162 linked to that goal 123. Once these criteria have been established as metrics 162 in system 120, organization 101 may begin collecting data for each metric 162 (e.g., metric data) which organization 101 may then analyze to track its progress toward achieving goal 123.

As an example and not by way of limitation, organization 101 may set a business objective 124 of collecting $20 million per year from sales of a particular product. Accordingly, to monitor the progress of this goal 123, organization 101 may define the relevant criteria needed to monitor this goal 123 as one or more metrics 162 in system 120. For example, one such metric 162 may be “gross refunds per week.” This metric 162 may indicate the amount of gross revenue lost to product refunds every week. Another relevant metric 162 may be “gross sales by week.” This metric 162 may indicate the amount of gross revenue derived from sales of the product every week. Depending upon the nature of the data to be collected, a metric 162 may be expressed as a measurement of business data in relation to one or more dimensions. In the above example, the measure would be dollars (gross sales) and the dimension would be time (by week). After organization 101 has defined the relevant metrics 162 needed to monitor goal 123, organization 101 may use system 120 to collect and organize the metric data into a readily understandable form.

As an additional example and not by way of limitation, organization 101 may be concerned about the risk 128 that its employees are not following organization 101's code of conduct and may establish a goal of mitigating that risk 128. Accordingly, organization 101 may define one or more metrics 162 needed to collect data relevant to this goal 123. One such metric 162 may be “Code of Conduct Reach.” This metric 162 may indicate a percentage of organization 101's employees that receive the code of conduct. Another relevant metric 162 may be “Code of Conduct Reachability.” This metric 162 may indicate the percentage of organization 101's workforce that believes the code of conduct is easily accessible. Such information could be obtained, for example, through an organization-wide survey. Another relevant metric 162 may be “Code of Conduct Control Failures.” This metric 162 may indicate the number of existing controls 122 related to familiarizing organization 101's employees with the code of conduct that were not operating as designed when tested. These and other metrics 162 may enable organization 101 to monitor the effectiveness of its efforts directed to mitigating risk 128.

Each metric 162 in system 120 may be defined by a corresponding metric definition. A metric definition includes the metric properties 163 of a particular metric 162. As an example and not by way of limitation, metric properties 163 may include an applicable type of units (e.g., dollars, percentage, or any other suitable unit(s) of measurement) for the data collected in metric 162a as well as a name for metric 162 which may be indicative of the type of data represented by metric 162. As an example and not by way of limitation, if metric 162 was named “Gross sales by week,” the units for metric 162 may be expressed as dollars per week. Metric properties 163 may further include information such as a unique numeric ID for metric 162, a person responsible for collecting and entering metric data for metric 162 (e.g., a metric owner), a category for metric 162 (e.g., risk metric, requirement metric, business objective metric, etc.), the key indicators 160 that are linked to metric 162, the goals 123 that are linked to metric 162, a collection frequency for collecting the metric data for metric 162, collection instructions for collecting the metric data for metric 162, as well as any other relevant information related to metric 162. In particular embodiments, the metric definition for each metric 162 may be defined by organization 101 to enable organization to create a customized set of metrics 162 tailored to monitor any goal 123.

Once organization 101 has defined the metrics 162 needed to monitor a particular goal 123, metric data (e.g., the collected data for metric 162) may be entered into system 120 using any suitable technique from any suitable source. As an example and not by way of limitation, metric data may be manually collected and entered into system 120 by an employee of organization 101 as part of their employment duties. As an additional example and not by way of limitation, metric data may be automatically imported into system 120 through the XOG from an external source (e.g., database) or automatically imported into system 120 from an electronic source using any other suitable method or mechanism. Depending upon the nature of the metric data being collected, organization 101 may gather such metric using, for example, surveys, software scans, test results, or any other suitable data collection technique.

In particular embodiments, each instance of metric data in system 120 may be produced by a corresponding metric event 164. A metric event 164 may be any event that produces a single instance of metric data as defined within system 120. As an example and not by way of limitation, if metric 162 is “gross sales by week,” the corresponding metric event 164 would be the weekly sales data for a single week. As an additional example and not by way of limitation, if metric 162 is “Code of Conduct Control Failures” as discussed in the example above, the corresponding metric event 164 would be the failure of a control 122 related to the code of conduct. Accordingly, each metric 162 contains metric data collected from several metric events 164. Over the course of time, system 120 may collect metric data from numerous metric events 124 which system 120 may periodically aggregate into a single aggregated value for metric 162. As discussed in more detail below, system 120 may then compare this aggregated value against a one or more predefined target values contained in a key indicator 160 to determine whether, at a particular moment in time, organization 101 appears to be on track to accomplish a goal 123.

Because many of organization 101's goals 123 may only be accomplished over an extended period of time and because other of organization 101's goals 123 may be perpetual objectives having no defined end, organization 101 may have a need to routinely assess metrics 162 to determine whether organization 101 appears to be meeting its goals 123. Consequently, in particular embodiments, system 120 may enable organization to establish one or more key indicators 160 to serve as progress markers against which system 120 may periodically compare the metric data for a particular metric 162 to determine whether the metric data indicates that organization 101 is on track to accomplish its goal 123 at a particular moment in time. Thus key indicators 160 may be used as a special form of metrics 162 to quantify objectives that reflect the strategic activity of organization 101. Key indicators 160 may be tied to organization 101's strategy and may differ from organization to organization depending on the nature of the organization and the organization's strategy. Key indicators 160 may help organization 101 to measure progress towards their organizational goals 123 and may be used to assess the present state of organization 101's business activities and to prescribe a course of action.

Each key indicator 160 in system 120 may be defined by a corresponding key indicator definition. A key indicator definition includes the key indicator properties 161 for a particular key indicator 160. A key indicator 160 typically includes three parts, a reporting frequency 168 that defines a time period (e.g., an aggregation period 169) over which the metric data for a particular metric 162 is to be monitored, an aggregation type 167 that defines a mathematical method (e.g. count, sum, average, minimum value, maximum value) for calculating an aggregated value from the metric events 164, and one or more thresholds 166 (e.g., target values) that define various levels of performance for the metric data during the aggregation period 169. Key indicator properties 161 may further include information such as the name of key indicator 160, a unique numeric ID for metric 162, an owner of key indicator 160, a type of key indicator 160 (e.g., a risk indicator, a requirement indicator, or a business objective indicator), a description of key indicator 160, a scheduled start date for reporting frequency 168, the units for key indicator 168, a scheduled end date for reporting frequency 168, the metrics 162 that are linked to key indicator 160, the goals 123 that are linked to key indicator 160, as well as any other relevant information related to key indicator 168. In particular embodiments, the key indicator definition for each key indicator 160 may be defined by organization 101 to enable organization to create a customized set of key indicators tailored to monitor any goal 123.

Reporting frequency 168 may be expressed in terms of any discrete period of time over which organization 101 desires to monitor the performance of a particular metric 162. For example, reporting frequency 168 may be monthly, quarterly, semi-annually, or any other suitable time period. Once the reporting frequency 168 for key indicator 160 has been established, system 120 may use reporting frequency to automatically aggregate the metric data from metric 162 into an aggregated value and compare the aggregated value against key indicator 160. For example, if reporting frequency 168 is monthly, the metric data being monitored may automatically be aggregated and compared with key indicator 160 at the end of each month.

In particular embodiments, system 120 may further enable a user of system 120 to perform an ad hoc aggregation and comparison for key indicator 160. An ad hoc aggregation may take place at any time. When a user of system 120 commands system 120 to perform an ad hoc aggregation and comparison for key indicator 160, system 120 may aggregate the metric data from the beginning of the current aggregation period 169 up to the date on which the ad hoc comparison is run. Additionally, a user of system 120 may perform an ad hoc aggregation to aggregate data between a specified range of dates. In any case, the metric data to be aggregated is determined by the relative start period and relative end period of the ad hoc aggregation. Once the aggregation is complete, system 120 may present the aggregated value for metric 162 to the user. Depending upon the design of system 120, system 120 may or may not compare an ad hoc aggregation value against the thresholds 166 in key indicator 160 because the ad hoc aggregation value may not be valid over the entire aggregation period 169.

In particular embodiments, the target values in key indicator 160 (e.g., thresholds 166) may only be valid for metric data which reflects a full aggregation period 169. Consequently, if aggregation period 169 is truncated by the ad hoc aggregation, system 120 may not compare the aggregated value against thresholds 166 if the aggregated value does not include data from the entire aggregation period 169. Alternatively, system 120 may be designed to modify thresholds 166 to suit the metric data aggregated during the truncated period of the ad hoc aggregation. In such a case, system 120 may compare the ad hoc aggregated value against modified thresholds 166.

As briefly mentioned above, to compare the metric data for a particular metric 162 against a key indicator 166, system 120 may aggregate the metric data from each of the metric events 164 occurring during the aggregation period 169 into a single aggregated value for that metric 162. System 120 may then compare the aggregated value for metric 162 against key indicator 160 by determining where the aggregated value falls in relationship to thresholds 166 included in key indicator 160. Different thresholds 166 may be representative of various levels of expected performance needed to achieve a goal 123. Therefore, the comparison of the aggregated value against thresholds 166 my indicate whether, during a particular time period (e.g., aggregation period 169), the metric data for metric 162 is under performing or out performing the target values needed to accomplish goal 123.

As an example and not by way of limitation, key indicator 160 may include a low threshold 166a, a high threshold 166b, a warning threshold 166c, and an escalation threshold 166d. A low threshold 166a may represent a target value below which the metric data is determined to be under performing the values needed to achieve goal 123. A high threshold 166b may represent a target value above which the metric data is determined to be out performing the values needed to accomplish goal 123, and the range of values between low threshold 166a and high threshold 166b may represent values for which the metric data is determined to be on track to accomplish goal 123.

A warning threshold 166c may represent a target value below which a warning message is generated by system 120 to alert a member of organization 101 that organization 101 is not on track to accomplish goal 123. For example, if the metric data for a particular metric 162 falls below warning threshold 166c, system 120 may send an e-mail or other electronic notification to the metric owner of that metric 162 alerting the metric owner of that the aggregated value for metric 162 has fallen below warning threshold 166c. Depending upon the threshold values chosen by organization 101, warning threshold 166c could be, for example, the same as low threshold 166a.

An escalation threshold 166d may represent a target value below which an escalation message is generated by system 120 to alert persons of high authority in organization 101 that organization 101 is not on track to accomplish goal 123. For example, if the metric data for a particular metric 162 falls below escalation threshold 166d, system 120 may send an e-mail or other electronic notification to one or more management members of organization 101 (e.g., CFO 52, CCO 54, CRO 66, or CIO 68) alerting them that the aggregated value for metric 162 has fallen below escalation threshold 166d. Typically, escalation threshold 166d falls below warning threshold 166c and represents a marker below which the metric data is determined to be severely under performing the values needed for organization 101 to accomplish goal 123. By alerting persons of high authority when the metric data for a particular metric 162 falls below escalation threshold 166d, system 120 may automatically keep the management of organization 101 abreast of any potential problems in accomplishing goal 123.

In particular embodiments, a goal 123 may be linked to multiple key indicators 160 that may indicate, alone or in combination, whether organization 101 is meeting goal 123. Depending upon the design of system 120, each key indicator 160 may be metric-specific. That is, each key indicator may be linked to a single metric 162. Accordingly, each key indicator 160 may need to be expressed in units that are consistent with the units of metric 162. As an example and not by way of limitation, if metric 162 is expressed in units of “dollars per week,” then the units of a corresponding key indicator 160 should also be expressed in “dollars per week.” By using consistent units across both metric 162 and key indicator 160, system 120 may ensure that metric data is compared on a common basis. In particular embodiments, system 120 may further include a units converter 170 that converts the units of metric 162 in the units of key indicator 160 before comparing the metric data from metric 162 against key indicator 160. For example, if a metric 162 is expressed in units of “Euros per week,” and key indicator 160 is expressed in units of “dollars per week,” units converter 170 may translate the units of metric 162 (i.e., Euros per week) into the units of key indicator 160 (i.e., dollars per week) in order to perform a proper comparison.

Depending upon the design of system 120, key indicator 160 may be linked to multiple metrics 162. In such a scenario, units converter 170 may perform any necessary units conversion to convert each of the metrics 162 linked to key indicator 160 into a common set of units. Once the units conversion is complete, system 120 may aggregate the metric data for each of the metrics 162 linked to key indicator 160 into a single aggregated value and may compare the aggregated value against key indicator 160 as described above.

In particular embodiments, once system 120 has aggregated metric data for the one or more metrics 162 linked to key indicator 160 and compared the aggregated value to key indicator 160, the aggregated value as well as the results of the comparison may be displayed to a user in a user-friendly dashboard. For example, system 120 may compare the results of aggregation for the present aggregation period 169 against the results for previous aggregation periods 169 and may display a trend indicator to the user that indicates how the metric data is progressing from aggregation period to aggregation period. For example, if the results from the current aggregation period 169 are poorer than the results for the previous aggregation period 169, system 120 may display an “DOWN” arrow to indicate that the metric data from the current aggregation period 169 is trending downward relative to metric data from the previous aggregation period 169. Similarly if the results from the current aggregation period 169 were better than the results for the previous aggregation period 169, system 120 may display and “UP” arrow to indicate an upward trend in the metric data.

In particular embodiments, system 120 may enable a user to create an aggregation job containing one or more criteria for creating a list of key indicators 160 (and corresponding metrics 162) that should be aggregated and compared each time the aggregation job is run. For example, the aggregation job may be scheduled to run routinely (e.g., daily, weekly, bi-weekly, etc.) through system 120 to ensure regular aggregation and comparison of metrics 162 and key indicators 160. Once the aggregation job is run, it may loop through all of the key indicators 160 and perform aggregation and comparison on the key indicators 160 meeting the selection criteria defined in the aggregation job.

In particular embodiments, the selection criteria included in the aggregation job may be defined with respect to the information included in the key indicator definition for each key indicator 160. Example criteria include key indicator type, key indicator units, aggregation period 169, or any other suitable information included in the key indicator definition for a key indicator 160. In an example situation, if aggregation period 169 is used as a selection criteria, then all key indicators 160 having an aggregation period 169 that ends between the date of the last aggregation job and the date of the current aggregation job will be selected for aggregation and comparison by system 120. Additional selection criteria may be added to or removed from the aggregation job to further limit the number of key indicators 160 that are selected for aggregation and comparison when the aggregation job is run. Using an aggregation job to select a subset of key indicators 160 for aggregation and comparison may enable system 120 to run more efficiently and may provide a user of system 120 with the ability to devote system resources to aggregation and comparison tasks at opportune times (e.g., during off peak hours).

As an alternative to using aggregation jobs to select various key indicators 160 for aggregation and comparison, system 120 may automatically aggregate and compare key indicators 160 with metrics 162 according to an aggregation schedule included in the key indicator definition for each key indicator 160. For example, system 120 may automatically aggregate and compare metrics 162 to key indicators 160 at the end of each aggregation period 169 for each key indicator 160.

For the sake of explanatory clarification, the following example scenario is presented to illustrate some of the above-mentioned features of system 120. Returning to the example scenario where organization 101 has set a goal 123 of raising $20 million gross revenue per year from sales of a particular product (“Product A”), organization 101 may monitor this goal 123 using a metric 162 and a key indicator 160. To capture revenue data for product A, organization 101 may create a metric 162 entitled “Gross Sales by Week—Product A” which may represent the amount of gross sales per week of Product A in dollars. To measure the performance of the revenue data in metric 162, organization 101 may create a key indicator 160 entitled “Quarterly Gross Revenue—Product A” which may include a number thresholds 166 to indicate the gross revenue needed each quarter from product A in order to accomplish goal 123. This key indicator 160 may include a low threshold 166a of $3.85 million, a high threshold 166b of $4.25 million, a warning threshold 166c of $3.7 million, and an escalation threshold 166d of $3.3 million. Key Indicator 160 may further be scheduled for aggregation and comparison at the end of each quarter.

When the end of the first quarter arrives, system 120 aggregates the metric data for each metric event 164 (e.g., the revenue figure for each week) into a single aggregated value for metric 162. System 120 may then compare this aggregated value against thresholds 166 to determine whether organization 101's gross sales of Product A are on track to meet organization 101's revenue goal for Product A at the end of the year. During the next quarter, the same process may be repeated to continually keep organization 101 abreast of its progress toward accomplishing goal 123. One of ordinary skill in the art will appreciate that the above-described scenario was presented for the sake of explanatory simplicity and will further appreciate that the present disclosure contemplates using system 120 to monitor any suitable goal 123 using any suitable combination and type of metrics 162 and key indicators 160.

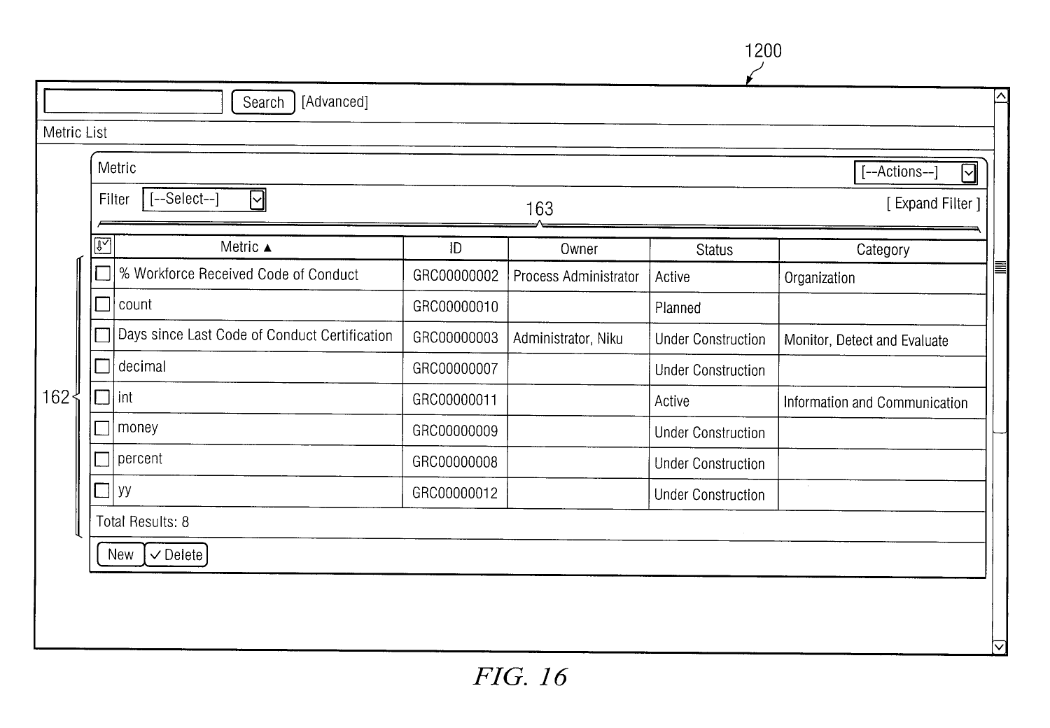

FIG. 16 illustrates an example portlet 1200 of system 120 that displays a list of metrics 162. Portlet 1200 may enable a user to view various metrics 162 by sorting, filtering, or searching metrics 162 using metric properties 163. Additionally, portlet 1200 illustrates various metric properties 163 for each metric 162. One of ordinary skill in the art will appreciate that portlet 1200 was presented for the sake of explanatory clarification and will further appreciate that the present disclosure contemplates presenting any suitable information regarding metrics 162 in any suitable layout in portlet 1200.

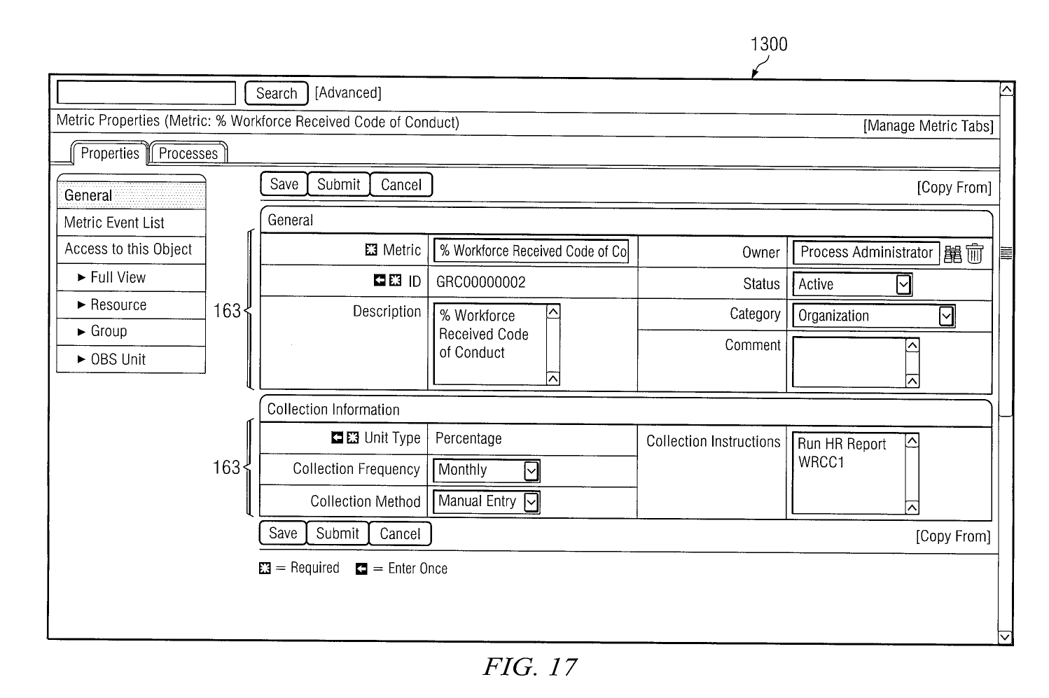

FIG. 17 illustrates an example portlet 1300 of system 120 that displays metric properties 163 for a metric 162. Portlet 1300 may enable a user to define metric properties 163 by entering information into system 120 using, for example, textual entry or drop down menus. One of ordinary skill in the art will appreciate that portlet 1300 was presented for the sake of explanatory clarification and will further appreciate that the present disclosure contemplates presenting any suitable information regarding metrics 162 in any suitable layout in portlet 1200.

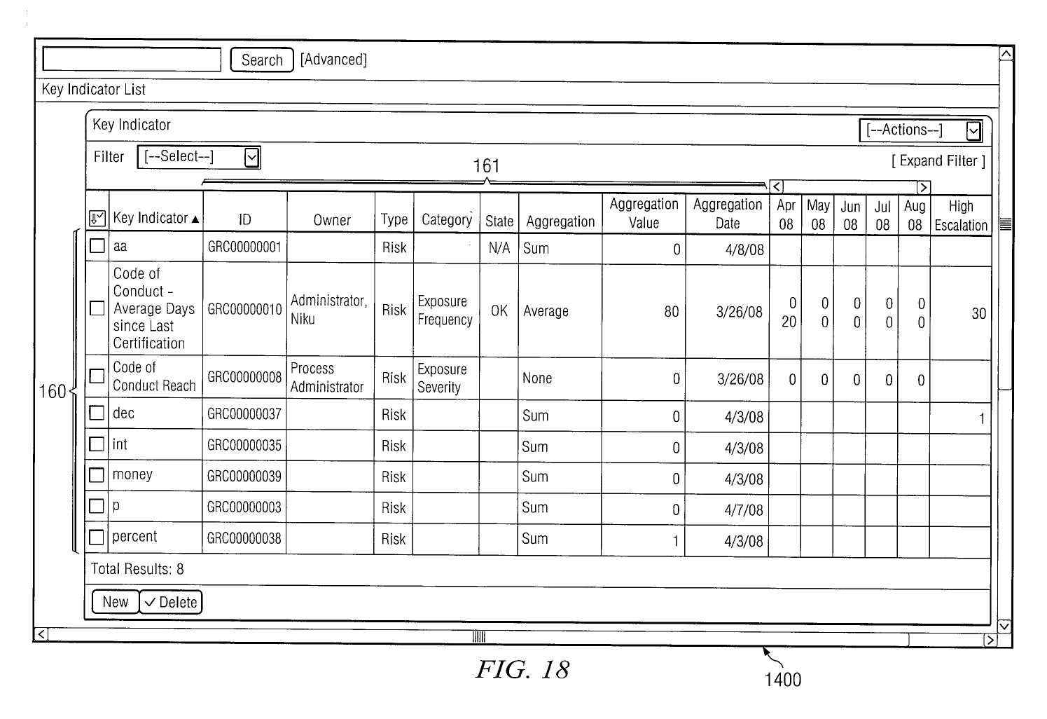

FIG. 18 illustrates an example portlet 1400 of system 120 that displays a list of key indicators 160. Portlet 1400 may enable a user to view various key indicators 160 by sorting, filtering, or searching key indicators 160 using key indicator properties 161. Additionally, portlet 1400 illustrates various key indicator properties 161 for each key indicator 160. One of ordinary skill in the art will appreciate that portlet 1400 was presented for the sake of explanatory clarification and will further appreciate that the present disclosure contemplates presenting any suitable information regarding key indicators 160 in any suitable layout in portlet 1400.

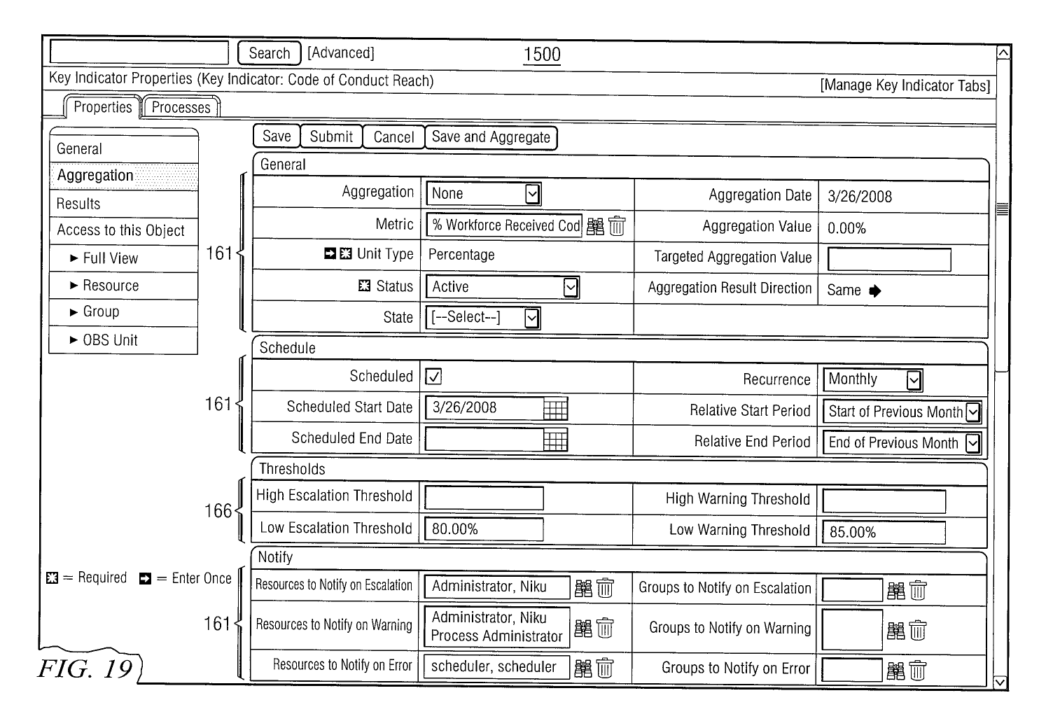

FIG. 19 illustrates an example portlet 1500 of system 120 that displays key indicator properties 161 for a key indicator 160. Portlet 1500 may enable a user to define key indicator properties 161 by entering information into system 120 using, for example, textual entry or drop down menus. One of ordinary skill in the art will appreciate that portlet 1500 was presented for the sake of explanatory clarification and will further appreciate that the present disclosure contemplates presenting any suitable information regarding key indicators 160 in any suitable layout in portlet 1500.

In addition to enabling organization 101 to monitor the progress of its goals 123 using key indicators 160 and metrics 162, in particular embodiments, system 120 may further enable organization 101 to create testing projects 142 to test controls 122 that have been implemented by organization 101 to achieve its goals 123 (e.g., mitigating a risk 128, achieving a business objective 124, satisfying a requirement 126, or managing an asset 150).

As mentioned above, oftentimes organization 101 may implement controls 122 as part of a larger program 140. Program 140 could be, for example, a SoX compliance program implemented by organization 101 to ensure that organization 101 has proper controls 122 in place to comply with the requirements 126 of SoX. Part of the SoX program 140 may include a testing project 142 to test each of the controls 122 implemented by organization 101 to comply with SoX. As controls 122 are tested, the test results (e.g., documentation of the testing) may be recorded into a test results archive in system 120 and linked to each control 122 as evidence that each control 122 has been tested. Moreover, the test results may be linked to corresponding requirements 126, business objectives 124, risks 128, and control objectives 130 for which the control 122 was implemented and reported to members of organization 101 or to certain third parties (e.g., auditors) to attest to the effectiveness of controls 122.

FIG. 20 illustrates an example view of a portion of system 120 which may enable organization 101 to create and manage projects 142 and programs 140 that facilitate the testing of controls 122. To facilitate the creation of a testing project 142, system 120 may enable a user to create project templates 172 and control templates 174 to standardize the controls 122 to be tested and tasks 178 to be performed as part of testing project 142. Moreover, control-specific information needed for testing each control 122 such as the person assigned to test control 122 and the estimated number of hours required to test control 122 may be recorded in a testing project configuration (“TPC”) 176 for each control 122.

By combining the information from project template 172 with information from one or more control templates 174 and one or more TPCs 176, system 120 may automatically create a testing project 142 containing a list of tasks 178 as well as the persons assigned to perform those tasks 178 in order to test each of the controls 122 included in the testing project 142. Each instance of testing for a particular control 122 may be recorded as a testing activity by system 120. Thus, each time a particular control 122 is tested (e.g., as part of test project 142), system 120 may document both the testing tasks 178 that were performed and the test results that were attained as evidence of the testing activity. By recording both testing tasks 178 as well as test results for each testing activity, organization 101 may demonstrate both the procedures that are in place to test controls 122 as well as the working status of controls 122 to members of management or to an outside party (e.g., for auditing purposes).

A testing project 142 may be implemented to test any logically related group of controls 122. As an example and not by way of limitation, a testing program 142 could be established to test all controls 122 linked to a particular requirement 126, asset 150, risk 126, business objective 124, or program 140. Because organization 101 may have numerous controls 122, system 120 may support multiple testing projects 142 to test different groupings of controls 122. For example, organization 101 may establish a broad testing program 140 to test all of its controls 122, in which case, testing program 140 may contain numerous testing projects 142, each directed to a different group of controls 122.

Once a testing project 142 has been created, testing project 142 may present organization 101 with a list of the tasks 178 that need to be completed for each control 122 as well as information regarding the status of each task 178 (e.g., the person responsible for performing each task 178, the completion status of each task 178, the results of each task 178, the estimated number of man hours devoted to completing each task, etc.). Any exceptions or deficiencies that occur during the testing of controls 122 may be recorded as issues 144 and logged as projects 142 for remediation that may further be managed using system 120. By encapsulating all of the tasks 178 needed to test a particular group of controls 122 in a single project 142, and by enabling organization 101 to track information such as the progress, cost, and results of each task 178, system 120 may enable organization 101 to test controls 122 using a project management-based approach.

By enabling organization 101 to test its controls 122 using a project management-based approach, system 120 may provide organization 101 with valuable insight into its controls testing efforts that might not otherwise be available to organization 101. For instance, organization 101 may use system 120 to gain a comprehensive view all of the costs involved with its testing efforts in a particular testing project 142. Additionally, system 120 may enable organization 101 to view and organize its testing efforts as a coordinated, centrally archived project 142 rather than as collection of uncoordinated of control-by-control tests.

In particular embodiments, the controls 122 included in testing project 142 may be defined by project template 172. For example, as part of implementing a testing project 142, a user of system 120 may create a project template 172 containing a list of all controls 122 that need to be tested as part of testing project 142. As an additional example, the user may call up a previously defined-project template 172 which the user may modify to suit the current testing project 142. In any case, project templates 172 may be used as an easy and efficient mechanism for organizing controls 122 into different testing projects 142.

Project templates 172 may further enable organization 101 to reuse previous work by providing a basis for creating repeatable testing projects 142. As an example and not by way of limitation, Organization 101's SoX compliance program 140 may require organization 101 to test all SoX-related controls 122 at regular intervals (e.g. semi-annually). Rather than having to define a new testing project 142 from scratch at the beginning of each interval, organization 101 may create a new testing project 142 by simply reusing the existing project template 172 from the previous interval. Thus, once a project template 172 has been defined, it may be reused again and again to identify the relevant controls 122 that need to be tested each time a new testing project 142 is required. One of ordinary skill in the art will appreciate that project templates 172 are but one of many mechanisms for defining the controls 122 to be tested as part of a testing project 142. For instance a user of system 120 may apply filtering criteria to controls 120 using the information associated with each control 122 to select a group of controls to be tested or the user may select controls 122 on an individual basis. Accordingly, the present disclosure contemplates the use of any suitable mechanism to determine which controls 122 targeted for testing as part of testing project 142.

In particular embodiments, the tasks 178 required to test each control 122 may be included in a control template 174. Since many of the tasks 178 needed to test a control may be repeated from control to control, control templates 174 may provide an efficient mechanism for organizing the tasks 178 needed to test a particular control 122 or type of control 122. For example, a control 122 may have its own individual control template 174 or it may be linked to a common control template 174 containing a generic set of tasks 178 suitable for testing multiple controls 122. In any case, the tasks 178 required to test each control 122 may be defined in the control template 174 to which the control 122 is linked through its TPC 176.

Control templates 174 may further enable organization 101 to reuse previous work by providing a basis creating a standard set of tasks 178 that may be applied to a particular control 122 each time that control 122 is selected for testing. One of ordinary skill in the art will appreciate that control templates 174 are but one of many mechanisms for defining the tasks 178 that need to be performed to test a control 122 and will further appreciate that the present disclosure contemplates the use of any suitable mechanism to determine which tasks 178 should be applied to test a particular control 122.

While the tasks 178 needed to test a control 122 may vary from control to control, a task 178 may be any procedure implemented by organization 101 to test or verify whether a control 122 is functioning properly. As an example and not by way of limitation, example tasks 178 for testing a control 122 include determining a test plan 134, creating and validating testing procedures, determining a sample size of the number of instances of a particular control 122 to be tested, determining resources (e.g., assets 150) that will be impacted by the testing, documenting the test plan 134, allocating resources for the testing, assigning a person to perform any testing tasks 178, performing any testing tasks 178, assigning a person to review the results of the testing tasks 178, signing off on the test results of the testing tasks (e.g. officially approving the test results), and archiving the test results. One of ordinary skill in the art will appreciate that the above-described tasks 178 were presented for the sake of explanatory simplicity and will further appreciate that the present disclosure contemplates using any suitable task 178 or combination of tasks 178 to test and verify whether a control 122 is functioning properly.

In particular embodiments, each control 122 may be linked to a separate TPC 176 containing control-specific information for each control 122. When a testing project 142 is created, system 120 may draw the control-specific information needed to assemble the test activities for each control 122 from each control's TPC 176. The control specific information in TPC 176 may include, for example, a reference to the control template 174 to which the control 122 is linked, the person responsible for completing the testing task(s) 178 for the control 122, the person responsible for reviewing the results of the testing, an estimated number of hours required to complete the testing of control 122, and an estimated number of hours to review the testing results. Particular controls 122 may not require testing and therefore, TPC 176 may further include a flag which indicates that control 122 does not require testing.

Because organization 101 may have numerous controls 122 (e.g., hundred or thousands), creating a TPC 176 for each control 122 may be a large undertaking. Accordingly, rather than requiring a user to individually create a TPC 176 for each control 122, system 120 may include a default configuration that may automatically fill in default information in a TPC 176 for a control 122 whose control-specific information was not otherwise specified by a user of system 120.

In an example situation, to create a testing project 142, a user of system 120 may select a project template 172 including a list of controls 122 that will be tested as part of testing project 142. Once the user has specified the list of controls 122 to be tested, system 120 may consult the control template 174 referenced in the TPC 176 for each control 122 and may compile a list of tasks 178 to be performed in order to test each control 122. System 120 may further consult the TPC 176 for each control 122 to determine a person or resource responsible for completing each task 178 and to determine whether a testing activity should be created for control 122.

After testing project 142 has been created, system 120 may further notify one or more responsible parties in organization 101 that they have been assigned a specific task 178 as part of testing project 142. As each party performs work on their respective task 178, they may enter the progress of their work into system 120. Such information may include for example, the number of hours invested in performing task 178 to date, as well as the percentage of the task 178 completed. Once task 178 has been completed, the results of the testing may be entered into the testing records of system 120 and any necessary documentation may be forwarded to the record-keeping division of organization 101 or electronically stored in system 120 for safe-keeping. As new or more current test results are obtained through subsequent testing activities, they may be copied into the test results archive which may be used to attest to the effectiveness of controls 122 (e.g., for auditing purposes). Test results may also be used to identify issues 144 that may then be addressed as additional remediation projects 142 using system 120.

In particular embodiments, once a testing project 142 has been created, system 120 may enable a user to modify one or more aspects of testing project 142 on the fly. As an example and not by way of limitation, the user may individually add or delete controls 122 from the project 142 on an ongoing basis. If a user deletes a control 122 from testing project 142, system 120 may automatically delete the tasks 178 and test results linked to the deleted control 122 from project 142. Likewise, if a control 122 is added to testing project 142, system 120 may automatically add the tasks 178 and test activities needed to test the added control 122 as described above. One of ordinary skill in the art will appreciate that the above-described example was presented for the sake of explanatory simplicity and will further appreciate that the present disclosure contemplates enabling the user to modify any suitable aspect of testing project 142 (e.g., task deadlines, responsible parties for performing tasks 178, etc.) as testing project 142 progresses.

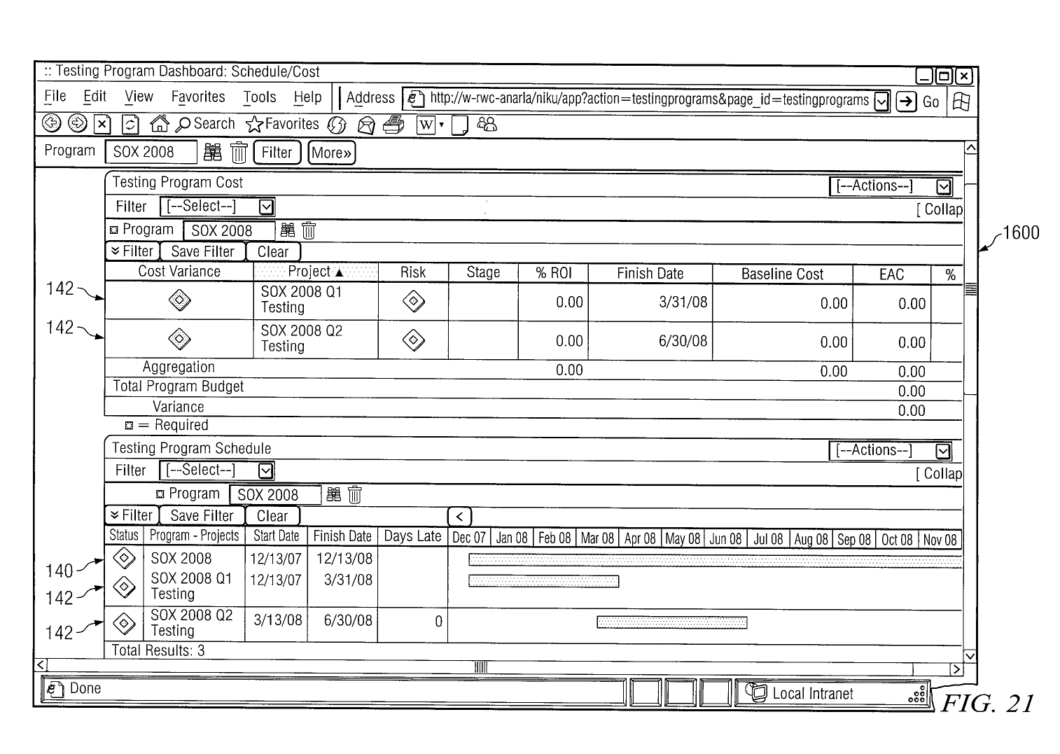

FIG. 21 illustrates an example portlet 1600 of system 120 that displays an overview of the testing projects 142 implemented by Organization 101 as part of a program 140 entitled, “SoX 2008.” Through portlet 1600, a user may view testing project information such as the cost associated with each testing project 142 and the project timeline associated with each testing project 142. For example the cost for a testing project 142 may be derived from the number of man hours needed to complete testing project 142. One of ordinary skill in the art will appreciate that portlet 1600 was presented for the sake of explanatory clarification and will further appreciate that the present disclosure contemplates presenting any suitable information regarding testing projects 142 in any suitable layout in portlet 1600.

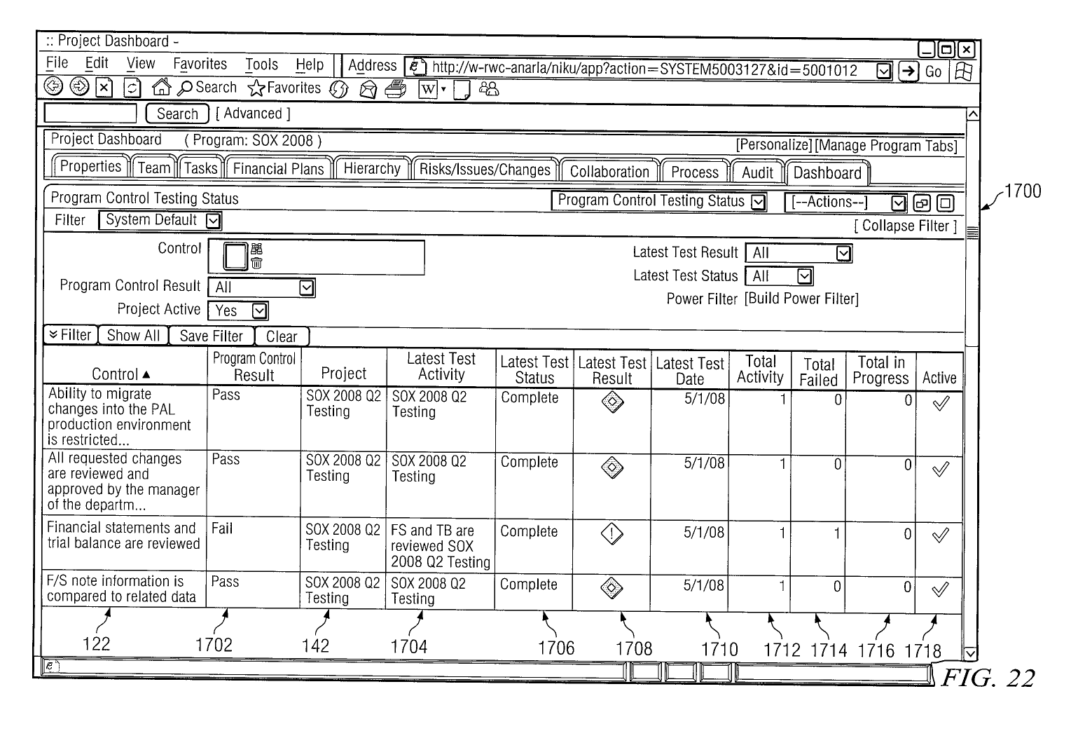

FIG. 22 illustrates an example portlet 1700 of system 120 that displays an overview of the testing of each control 122 implemented by Organization 101 as part of a program 140 entitled, “SoX 2008.” Through portlet 1700, a user may view testing information indicators such as a test result indicator 1702 that indicates the test result achieved during a particular testing project 142, a latest testing activity indicator 1704 that indicates the latest testing activity that took place for each control 122, the testing status indicator 1706 that indicates a status of the latest testing activity, a graphical test result indicator 1708 indicating the test result for the latest testing activity using a graphical marker, a test activity date indicator 1710 indicating the date of the latest testing activity, a total testing activity indicator 1712 indicating the total number of testing activities that have taken place for each control 122, a total number of failures indicator 1714 indicating the total number of times that a control 122 has failed a test, a tests in progress indicator 1716 indicating a total number of tests currently in progress to test a control 122, and an activity indicator 1718 indicating whether each control 122 in program 140 is currently active. Portlet 1700 may further enable a user to sort, filter, or search controls 122 using information in the control fields associated with each control 122. One of ordinary skill in the art will appreciate that portlet 1700 was presented for the sake of explanatory clarification and will further appreciate that the present disclosure contemplates presenting any suitable information regarding the testing of controls 122 included in a program 140 in any suitable layout in portlet 1700.

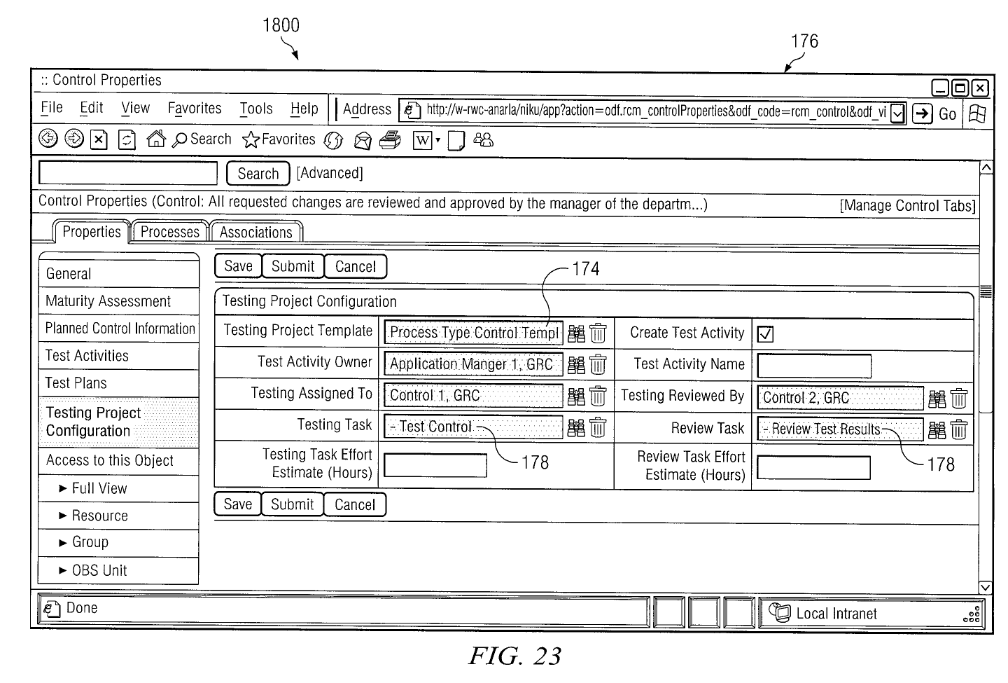

FIG. 23 illustrates an example portlet 1800 of system 120 that displays a TPC 176 for a control 122. Portlet 1800 may enable a user of system 120 to define the information included in TPC 176 by entering information using, for example, textual entry or drop down menus. One of ordinary skill in the art will appreciate that portlet 1800 was presented for the sake of explanatory clarification and will further appreciate that the present disclosure contemplates any suitable layout for TPC 176 in portlet 1800.

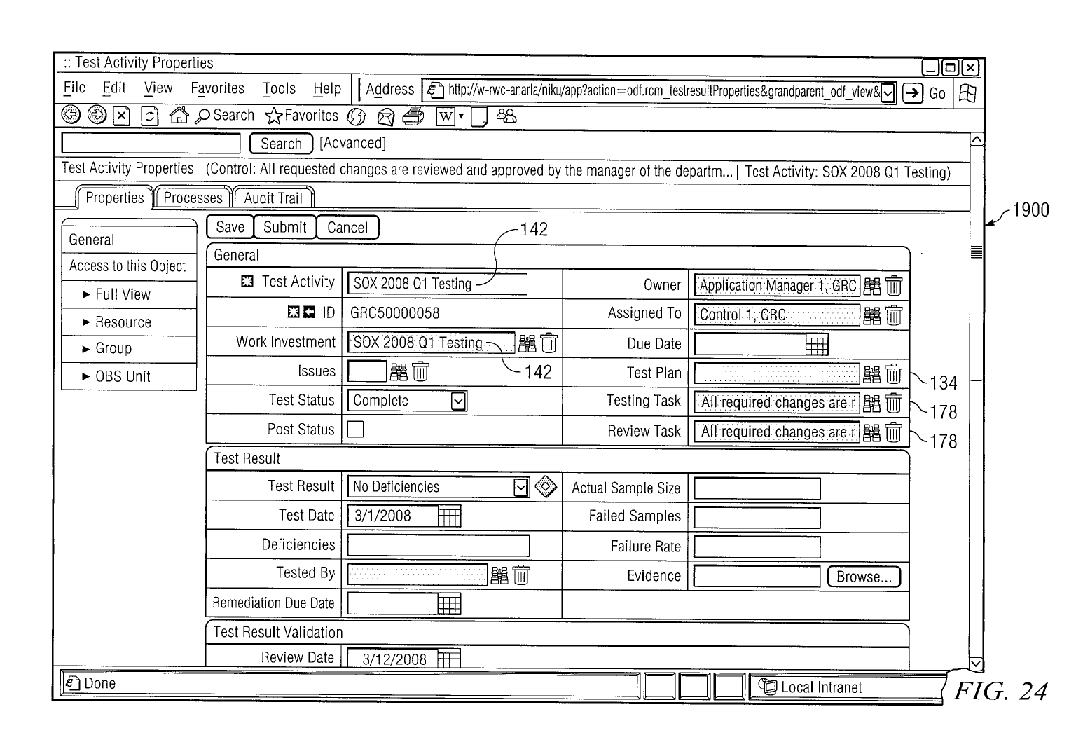

FIG. 24 illustrates an example portlet 1900 of system 120 that displays a testing activity that has been created for a control 122. In particular embodiments, a testing activity may be created for a single control 122 as part of a larger testing project 142 to test a group of controls 122. Alternatively, a testing activity may also be created to test a single control 122 independent of a testing project 142. In any case portlet 1900 may enable a user of system 120 to view or define various aspects of the testing activity. For example, portlet 1900 may enable a user to enter general information such as the testing project 142 associated with the testing activity, the owner of the testing activity, the person to which the testing activity is assigned, the testing project 142 to which any actuals (e.g., billable hours) should be attributed, the testing tasks 178 and review tasks 178 that are included in the testing activity, the test plan 134 for control 122, a due date for the test activity to be completed, and a test status (e.g., “Complete” or “In progress”) for the testing activity. In particular embodiments, if a test activity is created as part of a testing project 142, system 120 may automatically enter information into one or more field of portlet 1900. For example, system 1900 may automatically identify the testing project associated with the testing activity, as well as the testing tasks and review tasks included in the testing activity.

Portlet 1900 may also be used, for example, to enter test results for the testing activity. Test result information may include, for example, any deficiencies for control 122 that occurred during testing, a test date for the testing, a description of any deficiencies for control 122, an indication of the person who performed the testing, a due date for any remediation activities related to control 122, a sample size indicating the number of instances of control 122 that were tested, an indication of the number of samples that failed the testing, a failure rate (e.g., a percentage of the number of samples that failed per number of sample tested), and a link to any evidence of the testing. Portlet 1900 may further be used to establish a review date one which the results for the testing activity should be reviewed. Depending upon design, portlet 1900 may enable a user of system 120 to enter information using, for example, textual entry or drop down menus. One of ordinary skill in the art will appreciate that portlet 1900 was presented for the sake of explanatory clarification and will further appreciate that the present disclosure contemplates any suitable layout for portlet 1900.

As previously discussed, organization 101 may use system 120 to manage and implement controls 122 in order to accomplish various goals 123 such as mitigating a risk 128, achieving a business objective 124, or complying with a requirement 126. Furthermore, system 120 may enable organization 101 to develop one or more metrics 162 to collect various kinds of data (e.g. metric data 190) relevant to measuring the accomplishment of goal 123. In particular embodiments, an information governance system 180 may provide metric data 190 corresponding to the documents of organization 101 to system 120 so that system 120 may allow organization 101 to track its progress towards achieving goal 123.

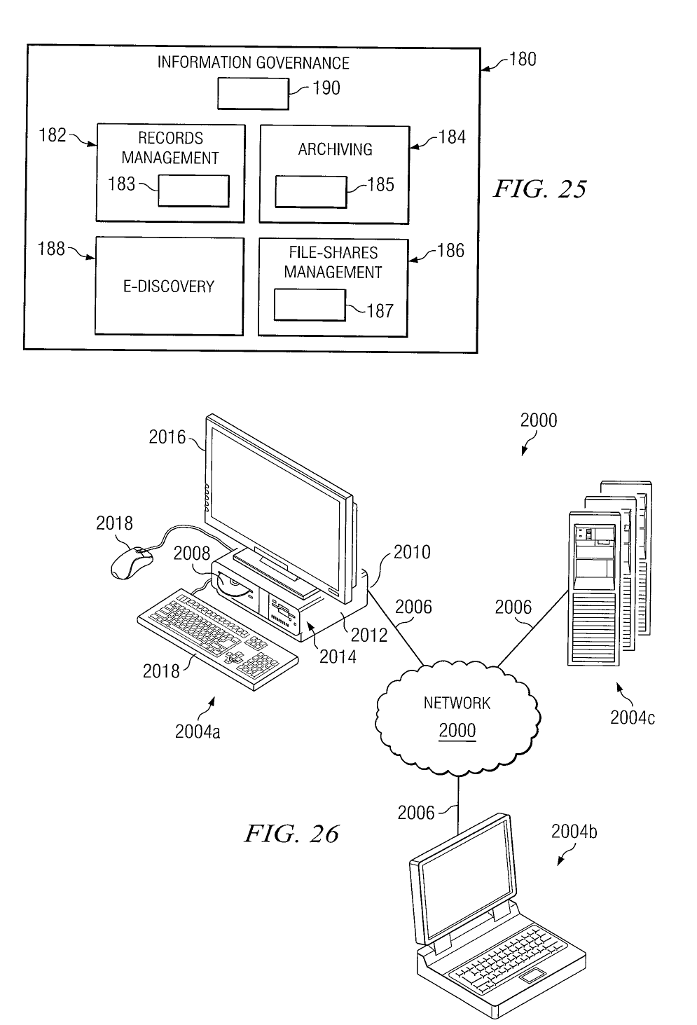

FIG. 25 illustrates an example view of information governance system 180 which may manage documents of organization 101, and provide metric data 190 to system 120 for tracking organization 101's progress towards achieving a goal 123. Information governance system 180 includes records management 182, archiving 184, file-shares management 186, e-discovery 188, and metric data 190, each of which represent a logical container for various types of information and/or data related to organization 101. In particular embodiments, using records management 182, archiving 184, file-shares management 186, and e-discovery 188, information governance system 180 may manage documents for organization 101.

For the sake of explanatory convenience, managing documents may generically refer to storing documents, backing-up documents, creating new documents, deleting documents, preventing the deletion of documents, tracking documents, linking to documents stored elsewhere, importing documents, exporting documents, and controlling and/or handling documents in any other way. Furthermore, documents may generically refer to electronic documents, physical documents, native documents, unstructured documents, structured content, electronic files, electronic media, metadata, records, non-records, file-shares, any data related to organization 101, or any other type of data or information that may be managed. In particular embodiments, managing documents may include storing an electronic document on a database. Managing documents may further include keeping track of where a physical document is stored (e.g., in a warehouse, in a file cabinet, etc.) and also keeping track of who has accessed the physical document. In particular embodiments, the actions performed against documents may be audible to prove the provenance of the documents.

Records management 182 may manage records 183 for organization 101. Records 183 may include any type of document associated with goals 123, business objectives 124, requirements 126, or risks 128. For example, records 183 may be documents that need to be retained for legal, regulatory, or business reasons as uneditable and provable original documents. As another example, records 183 may be documents required by one or more federal regulations (e.g., HIPPA or SoX). For instance, SoX may impose a requirement 126 on organization 101 requiring organization 101 to maintain a secure data network. As such, records 183 may include documents dealing with organization 101's implementation of a secured data network, such as, for example, e-mails confirming that the secured data network has been set-up, and technical documents describing how the secured data network has been implemented. In particular embodiments, records 183 may include documents associated with controls 122. For example, organization 101 may implement a control 122 requiring that energy efficient light bulbs be used in its buildings. As a result, records 183 may include documents associated with approval of this control 122, steps initiated to satisfy this control 122, results of testing this control 122, and invoices associated with implementing this control 122. In a further embodiment, records 183 may include any type of documents whose management by records management 182 is required, for one reason or another, by organization 101.

In particular embodiments, due to the types of documents included in records 183, records management 182 may manage documents for a long period of time. As one example, federal regulations require that ex-employee records be kept by an organization 101 for seven years after the employee is no longer employed by the organization. Accordingly, records 183 may include all ex-employee records falling under such federal regulations. As such, records management 182 may manage an ex-employee's records (e.g., storing the records, tracking the records, etc.) for at least seven years. After the seven years has expired, records management 182 may continue to store the ex-employee's records (e.g., if a control 122 requires the storage of such records for longer than seven years), or records management 182 may destroy the employee's records (e.g., if a control 122 requires the destruction of such records after seven years has expired).

Since records 183 may have differing life cycles, records management 182 may further manage each record 183 for a different period of time. For example, records management 183 may manage the articles of incorporation of organization 101 for the entire lifetime of organization 101, but may only manage an ex-employee's records for seven years.

Archiving 184 may manage non-records 185 for organization 101. Non-records 185 may include any document that is not associated with goals 123, business objectives 124, requirements 126, or risks 128. For example, non-records 185 may include documents that do not need to be retained for legal, regulatory, or business reasons as an uneditable and provable original documents. As another example, non-records 185 may include general correspondence e-mails. For instance, many correspondence e-mails (e.g., an e-mail from an employee to a family member regarding a birthday party) have nothing to do with various government regulations (e.g., HIPPA or SoX), and therefore, there may be no current legal or business reason to store such e-mails.

Since non-records 185 may not be associated with goals 123, business objectives 124, requirements 126, and risks 128, non-records 185 may be less relevant to organization 101 than records 183. Accordingly, archiving 184 may manage non-records 185 for shorter periods of time than records 183 may be managed by records management 182. For example, a correspondence e-mail stored as a non-record 185 in archiving 184 may be managed for only a few months, as opposed to the seven years that an ex-employee's records may be managed as a record 183 by records management 182.

Due to the differing life cycles of non-records 185 (e.g., correspondence from the CEO of organization 101 may have more relevance to organization 101 than correspondence from a low level employee, and thus, the CEO's correspondence may have a longer life cycle), archiving 184 may manage each non-record 185 for a different period of time. As one example, archiving 184 may manage a correspondence e-mail from the CEO of organization 101 for a year, but may only manage a correspondence e-mail from a low level employee for a few months.

In particular embodiments, although non-records 185 may include documents that are initially not associated with goals 123, business objectives 124, requirements 126, or risks 128, the non-records 185 may, for one reason or another (i.e., changes in federal regulations, the filing of lawsuits, inquiries by organization 101, being categorized as part of a discovery process, etc.), become subsequently associated with goals 123, business objectives 124, requirements 126, or risks 128 of organization 10. For example, a correspondence e-mail may initially have nothing to do with requirements 126, but may become associated with a requirement 126 as a result of impending litigation and discovery requests. Accordingly, archiving 184 may manage any non-records 185 that become associated with goals 123, business objectives 124, requirements 126, or risks 128 of organization 101 for longer periods of time. In particular embodiments, archiving 184 may transfer documents to records management 182 when the documents become associated with goals 123, business objectives 124, requirements 126, or risks 128 of organization 101. As a result, records management 182 may manage the documents for longer periods of time.

File-shares management 186 may manage file-shares 187 for organization 101. File-shares 187 may include any document that is stored independently from a document management system. For example, file-shares 187 may include documents that are only stored on a computer hard drive. Since the documents are only stored on the computer hard drive, they are not stored on a document management system, and therefore, may only be accessed at the computer, itself. In particular embodiments, such documents may be created when an employee chooses to save a document to the computer hard drive instead of a document management system, or when a computer does not have access to the internet.

File-shares 187 may further include any document that is stored on any type of storage medium (e.g., floppy disks, CDs, external hard drives, etc.) independent of a document management system. For the sake of explanatory convenience, a document management system may generically refer to any type of document storage that enables documents to be accessed at different access points. For example, a document management system may include a database accessible from at least two access points, or an electronic storage unit that can be accessed by multiple parties over the internet. In particular embodiments, file-shares 187 may also include documents that are both stored independently from a document management system and also stored on a document management system. As one example, file share 187 may include a document that is saved on a computer hard drive and also saved on a document management system.

File-shares 187 may include documents that are both associated and not associated with goals 123, business objectives 124, requirements 126, and risks 128. For example, an employee of organization 101 may save drafts of documents that are associated with a goal 123 of organization 101 on their own hard drive instead of a document management system of organization 101. Accordingly, file-shares management 186 may manage file-shares 187 for both longer periods of time and shorter periods of time.

In order to manage file-shares 187, file-shares management 186 may import file-shares 187 into file-shares management 186. For example, file-shares 187 may be uploaded onto file-shares management 186 from a computer hard drive. Alternatively, file-shares 187 may remain only on the computer hard drive, and file-shares management 186 may track which computer hard drive the documents are on, and where the computer is located.

E-discovery 188 may assist organization 101 with any discovery-related needs. For the sake of explanatory convenience, discovery may generically refer to the legal requirement to disclose information that is associated with litigation or regulatory inquiry, organization 101's process of finding information regarding possible litigation, organization 101's process of retaining information in anticipation of possible litigation, or any other requirements or needs imposed by the process of litigation.

E-discovery 188 may enable organization 101 to respond to discovery requests. For example, upon receiving a discovery request, e-discovery 188 may provide organization 101 with the ability to search for certain documents, place certain documents on hold, review certain documents, prepare certain documents for production (e.g., request that certain documents be retrieved from storage units, prepare certain documents to be converted to, or held in, the format required by the discovery request, create document maps that indicate where each document is stored, etc.), keep track of what documents have already been produced, and keep track of dates associated with each discovery request. In particular embodiments, e-discovery 188 may allow for the creation of discovery request calendars and the management of such calendars. As a result, e-discovery 188 may provide organization 101 with an efficient way to respond to discovery requests and any other litigation-related matters.

E-discovery 188 may further provide access to documents in records management 182, archiving 184, and file-shares management 186 so as to allow such documents to be viewed by a user. Accordingly, during litigation matters, e-discovery 188 may provide organization 101 with a way to accomplish document review for privilege, confidentiality, responsiveness, etc. E-discovery 188 may further search for documents in records management 182, archiving 184, and file-shares management 186 so as to change the status of such documents. As an example, based on litigation, e-discovery 188 may search for documents in archiving 184, and place a hold on such documents in order to prevent their editing or destruction (e.g., as is a requirement imposed by federal regulations). As a result, e-discovery 188 may extend the life cycle of documents in records management 182, archiving 184, and file-shares management 186. In particular embodiments, once the litigation-imposed hold on documents are no longer needed, e-discovery 188 may remove the hold on the documents in records management 182, archiving 184, and file-shares management 186, thereby allowing such documents to be destroyed in accordance with certain controls 122.

E-discovery 188 may also manage documents. For example, e-discovery 188 may store discovery requests received by organization 101. As another example, e-discovery 188 may create, update, and store document maps that provide information about documents in information governance system 180. Document maps, for example, may include names, types, dates, location, and content of documents. In particular embodiments, e-discovery 188 may mange any other information of organization 101 associated with the process of litigation. For example, e-discovery 188 may create and store a record of every action taken by e-discovery 188, or of every action taken by organization 101 in response to litigation.

In particular embodiments, e-discovery 188 may provide organization 101 with the ability to automatically respond to a litigation-related matter. For example, as discussed above, e-discovery 188 may automatically create, update, or store document maps of any document that may be requested by organization 101, a court, or a third party in a litigation matter. As a further example, e-discovery 188 may automatically create, update, and store a list of documents produced. In another embodiment, e-discovery 188 may assist a user of e-discovery 188 in responding to a litigation-related matter. As an example, a user of e-discovery 188 (e.g., a lawyer of organization 101) may use e-discovery 188 to review a discovery request in order to determine which documents would be responsive to the discovery request. Once the user has determined which documents are responsive, the user may use e-discovery 188 in order to search for such documents, place such documents on hold, and prepare such documents for further review.

Metric data 190 may represent any data from information governance system 180 that may be transferred to system 120. Metric data 190 may include data from each of records management 182, archiving 184, file-shares management 186, and e-discovery 188. For example, metric data 190 may include data regarding how many records 183 are stored in records management 182, which non-records 185 in archiving 184 have been placed on a destruction hold, the date that file-shares 187 were last updated in file-shares management 186, and how many discovery requests have been submitted to organization 101.

Metric data 190 may include any type of data regarding documents managed by information governance system 180. For example, as discussed above, records management 182 may manage ex-employees' records for at least seven years in accordance with federal regulations. As such, metric data 190 may include any data regarding such ex-employees' records. For example, metric data 190 may include the names of each ex-employee, the data of the termination of each ex-employee, how many ex-employees' records are still managed by records management 182, how many ex-employees' records have been placed on a destruction hold, how many ex-employees' records have been destroyed, the date of the destruction of each ex-employee's record, etc.

As a further example, metric data 190 may include any type of data regarding any physical document that is not stored in records management 182, but is managed by records management 182. For example, metric data 190 may include the contents of the physical documents, the relevance of the physical documents, the location of the physical documents, who is in charge of the physical documents, how the physical documents can be accessed or requested, how to access an electronic copy of the physical documents, the name of each person who has accessed the physical documents, the number of times the physical documents have been produced, etc.

Metric data 190 may further include any data for controls 122. For example, a control 122 may require that documents requested by a discovery request be produced within a set time frame, for example, two days before the production date of the discovery request. Accordingly, metric data 190 may include data regarding each discovery request received by organization 101, which documents were produced pursuant to each discovery request, when the documents were produced, whether or not the documents were produced at least two days before the date mandated in the discovery request, the reason the documents were not produced in accordance with the control 122 (e.g., an extension was granted), etc.

Metric data 190 may also include any type of data corresponding to monitoring organization 101's progress towards achieving a goal 123, or any type of data corresponding to monitoring organization 101's progress towards achieving a goal 123 at a particular point in time. As such, metric data 190 may include any type of data associated with metrics 162 and key indicators 160. As an example and not by way of limitation, organization 101 may set a goal 123 of raising $20 million gross revenue per year from sales of a particular product (“Product A”). Organization 101 may monitor this goal 123 using a metric 162 entitled “Gross Sales by Week—Product A,” and a key indicator 160. Consistent with this metric 162 and key indicator 160, metric data 190 may include data from organization 101's balance sheets for each week. Specifically, metric data 190 may include an amount of gross sales of product A for a week, and the date of the week the data corresponds to. Accordingly, in particular embodiments, metric data 190 may include data that is useful to system 120.

Due to the need of system 120 for metric data 190, information governance system 180 may provide metric data 190 to system 120. As such, metric data 190 of information governance system 180 may enable organization 101 to monitor organization 101's progress towards achieving a goal 123, and monitor organization 101's progress towards achieving a goal 123 at a particular point in time. For example, with regard to the goal 123 discussed above regarding raising $20 million gross revenue per year from sales of Product A, metric data 190 may include data corresponding to the sales of product A for a week. Accordingly, metric data 190 may enable organization 101 to determine whether goal 123 has or has not been achieved (e.g., using metric 162), whether organization 101 is ahead or below the scheduled progress for reaching goal 123 (e.g., using high threshold 166a and low threshold 166b), or whether a high level executive officer needs to be alerted to the status of the goal 123 (e.g., using a warning threshold 166c or an escalation threshold 166d).

As a further example, a control 122 of organization 101 may require that documents for a discovery request be produced within a set time. Based on this control 122, organization 101 may have a goal 123 of only failing to meet the control 122 once during a corresponding amount of time. In order to monitor organization 101's progress toward meeting this goal 123, organization 101 may set up a metric 162, key indicators 160, and thresholds 166 dealing with the progress towards this goal 123. Furthermore, using e-discovery 188's management of discovery requests, metric data 190 may include data corresponding to each discovery request deadline and whether or not the documents were produced within the set time. When this metric data 190 is provided to system 120 by information governance system 180, system 120 may enable organization 101 to track organization 101's progress towards meeting this goal 123. Specifically, if organization 101 has not missed any set time frames for production, system 120 may indicate to organization 101 (e.g., using both metric data 190 and high threshold 166a) that organization 101 is outperforming the values needed to accomplish goal 123. However, if organization 101 has already missed three set time frames for production, system 120 may indicate to organization 101 (e.g., using both metric data 190 and metric 162) that organization 101 has failed to meet its goal 123.

Providing metric data 190 to system 120 may further enable system 120 to more efficiently test a control 122. For example, as discussed above, a control 122 may require that documents listed in a discovery request be produced within a set time frame, such as two days before the due date of the discovery request. As such, metric data 190 may include information regarding when each discovery request has been satisfied. As a result, if a high level executive officer (e.g., CCO 54) wants to know how organization 101 is complying with the control 122 regarding discovery request production time frames, CCO 54 may access metric data 190 for control 122 and determine whether or not the control 122 is being met. In particular embodiments, metric data 190 for each control 122 may be accessed at one or more dashboards that may organize and present the information in a user-friendly way. Additionally the testing of control 122 may be automatic, and may provide alerts to a high level executive officer when metric data 190 of control 122 indicates that control 122 is not being met.

In order to provide metric data 190 to system 120, information governance system 180 may transfer metric data 190 to system 120 using any suitable method. For example, metric data 190 may be automatically transferred from information governance system 180 to system 120 using an Extensible Markup Language “XML” Open Gateway “XOG” that may enable information governance system 180 to export relevant information to system 120. According to one example, the XOG may support both XML and “Web Service Definition Language “WSDL” integration methods. The XOG may be used to initially populate system 120 with metric data 190 on-going data feeds and data synchronization with information governance system 180. Additionally, metric data 190 may be transferred from information governance system 180 to system 120 in regular intervals. For example, metric data 190 may be transferred to system 120 every day, every week, every couple of weeks, etc. In particular embodiments, information governance system 180 may transfer metric data 190 to system 120 when the metric data 190 is requested. For example, metric data 190 may be transferred when a user requests the transfer of metric data 190, or when system 120 automatically requests the metric data 190. In one embodiment, an automatic request from system 120 for metric data 190 may occur pursuant to a control 122.

As discussed above, information governance system 180 may manage documents for organization 101. In particular embodiments, information governance system 180 may further manage a document of organization 101 as an original document, while still allowing the document to be accessed. For example, information governance system 180 may provide a central management system that controls the managed document so as to allow organization 101 to prove that the documents is original. Furthermore, information governance system 180 may provide document links to system 120 so as to allow a user of system 120 to access the document while the document remains under the management of information governance system 180.

Typically, in the regular course of business of organization 101, documents are constantly created, modified, and deleted. Furthermore, the documents may pass through many departments, and be used by many employees, of organization 101 during the regular course of business. Unfortunately, this may create a situation where the original document is lost, or the original document cannot be proved as the original document. For instance, due to technological advancements, it is possible to manipulate documents to include false data and still look original. As such, proving that a document is original requires more than merely producing the document.

Under certain circumstances, this may create problems. For example, in order to comply with various federal regulations (e.g., HIPPA or SoX), organization 101 may need to produce various documents. In doing so, these documents may need to proved as original, which as discussed above, may be a problem. Furthermore, even when an organization 101 is able to prove that a document is original, the process of doing so sometimes requires that the document be inaccessible to employees and departments of organization 101. For example, in order to preserve documents as original, the documents may need to be stored in areas that are inaccessible to the employees of organization 101. Thus, although the document is original, it is useless to organization 101 for business purposes.

Accordingly, information governance system 180 may provide a central system for managing each of the documents of organization 101. As a central system, information governance system 180 may have access to each and every document of organization 101. For example, if a document is created on a system different from information governance system 180, the document may be imported to information governance system 180 in order to be managed. As another example, documents that float around organization 101 (e.g., e-mails) may flow through information governance system 180 for management purposes. In particular embodiments, although every document may be accessed by information governance system 180, information governance system 180 may choose to not manage certain documents.

With every document of organization 101 flowing through, or being accessed by, information governance system 180, information governance system 180 may be able to manage each document of organization 101. By doing so, information governance system 180 may enable organization 101 to ensure that each document remains as a provable original record. For example, information governance system 180's ability to manage each document may enable information governance system 180 to also preserve each document in its original format, including any original metadata associated with the document. As a result, when needed (e.g., when organization 101 must provide an original document to comply with various federal regulations, or to a court) organization 101 may use information governance system 180 to prove that the document is indeed original.

Information governance system 180 may further allow documents of organization 101 to be accessed while the documents remain provable as original. For example, metric data 190 may include a document link to each document of information governance system 180, allowing the document to be accessed. As a result, once metric data 190 is transferred to system 120, as discussed above, the document may be accessed from system 120 using the document link. For the sake of explanatory convenience, a document link may refer to a link that can access documents in any way, a clickable button that accesses a version of a document, textual content that explains how a document may be accessed, or any other way to electronically access a document.

Using a document link, a document may be accessed in any type of format that allows the document to be modified (e.g., MICROSOFT EXCEL spreadsheets, homegrown applications, word processing documents, MICROSOFT POWERPOINT slides, etc.). In particular, when a modifiable document is accessed using a document link, an unoriginal version of the document may be accessed, and not the original document. As a result, the original version of the document may remain unmodified, but a user may be able to use and modify a copy of the document. Thus, the document may be used in the regular course of business. Furthermore, any modifications to an accessed document may be stored in information governance system 180 as an updated document. Accordingly, the original document may remain provable as an original, and the updated document may remain provable as an original updated document. Alternatively, a document may be accessed, using a document link, in any type of format that does not allow the document to be modified (e.g., a “read only” copy of a word processing document, an un-editable PDF, etc.). Accordingly, the document may be accessed without affecting the ability to prove the originality of the document.

Information governance system 180 may further allow physical documents to be accessed using a document link. For the sake of explanatory convenience, a physical document may refer to any document on paper, any document that has physical traits (e.g., as opposed to including only electronic data), or any other document that cannot be stored using only electronic means. In particular embodiments, a document link to a physical document may provide access to an electronic version of the physical document. Furthermore, a document link to a physical document may provide a description of the document, a summary of the text of the document, the location of the document (e.g., stored in a warehouse, located in a file cabinet), instructions on how to access the document, and instructions on how to request the document. As a result, the document link may provide access to the physical document.

Once a document link is transferred to system 120 as metric data 190, the document link may be presented on system 120. As a result, a user of system 120 may be able to use the document link to access the document. Furthermore, the document link may be presented at one or more dashboards that may organize and present the document link and any subsequent information in a user-friendly way.

FIG. 26 illustrates an example network 2000, having one or more components which may implement information governance system 180 to manage documents of organization 101, and provide metric data 190 to system 120 for tracking organization 101's progress towards achieving goal 123. In particular embodiments, network 2000 may include one or more local area networks (LAN), one or more wireless LANs (WLAN), one or more wide area networks (WAN), one or more metropolitan area networks (MAN), a portion of the Internet, or another form of network or a combination of two or more such networks. The present disclosure contemplates any suitable network 2000 or combination of networks 2000. In particular embodiments, components of network 2000 are distributed across multiple cities or geographical regions. In particular embodiments, network 2000 may be represented by multiple distinct, but interconnected networks that share components or distinctly contain similar components. Distinction between networks and network components may be defined, for example, by geographic location, individual ownership, differing network architectures, or other distinction.

Example components of network 2000 include one or more clients 2004 coupled to network 2000 via one or more links 2006. In particular embodiments, links 2006 may each include one or more wireline, wireless, or optical links. In particular embodiments, one or more links 2006 each include a LAN, a WLAN, a WAN, a MAN, a portion of the Internet, or another link 2006 or a combination of two or more such links 2006. Each of the components coupled to network 2000 communicate with each other via use of network 2000.

Each of clients 2004 may include any component of hardware or software or combination of two or more such components operable to provide data management services. As an example and not by way of limitation, one or more clients 2004 may be a personal computer (2004a), a laptop (2004b), a plurality of servers (2004c), a personal digital assistant (PDA), or another computing device that may include an interface 2010, one or more processors 2014, and a memory 2012 comprising or capable of receiving program instructions recorded on a tangible computer readable media 2008 (e.g., a cd-rom, a flash drive, a floppy disk, etc.) that when executed by processors 2014 perform some or all of the functionality described herein. In particular embodiments, organization 101 may own and/or operate a number of clients 2004 and/or may employ the services of one or more third parties owning other clients 2004 to provide itself document management services according to particular embodiments of the present disclosure.

Processor 2014 may be a microprocessor, controller, or any other suitable computing device, resource, or combination of hardware, software and/or encoded logic operable to provide, either alone or in conjunction with other components of network 2000 (e.g., memory 2012) computer-based functionality of particular embodiments of the present disclosure. Accordingly, memory 2012 may be any form of volatile or non-volatile memory including, without limitation, magnetic media, optical media, random access memory (RAM), read-only memory (ROM), removable media, or any other suitable local or remote memory component and interface 2010 may comprise any hardware, software, or encoded logic operable to send and receive information to and from other components of network 2000 such as other clients 2014. Such functionality may include providing various features discussed herein to a user via suitable output device(s) 2016 (e.g., a monitor or printer) and/or receiving input from a user via suitable input device(s) 2018 (e.g., a keyboard or a mouse). Interface 2010 may refer to a single interface, or more than one interface. In particular embodiments, all of the functionality and features of information governance system 180 may reside and be performed on a single client 2004, or may reside and be performed in a distributed fashion amongst multiple clients 2004 across network 2000. In particular embodiments, all of the functionality and features of information governance system 180 may reside and be performed on a different client 2004 than the functionality and features of system 120. As such, the client 2004 employing the functionality and features of information governance system 180 may access system 120 of network 100 (shown in FIG. 4) using network 2000. Particular features described herein may be implemented, for example, in the form of a database computer program, portions or which may be web-based, operating on any suitable client(s) 2004 in network 2000 operable to manage documents of organization 101, and provide metric data 190 to system 120 for tracking organization 101's progress towards achieving goal 123.

Although the present disclosure has been described in several embodiments, a myriad of changes, substitutions, and modifications may be suggested to one skilled in the art, and it is intended that the present disclosure encompass such changes, substitutions, and modifications as fall within the scope of the present appended claims.

What is claimed is:

1. A method for governance, risk, and compliance management, comprising:
providing an interface for defining a control to be used to reach a goal of an organization, the control providing a procedure to be followed by the organization;
providing the interface for implementing the control in order to reach the goal of the organization;
receiving metric data from an external source, the metric data including a document link; and
providing the interface for accessing, using the document link, one or more documents corresponding to the control, the one or more documents being accessed in such a way as to prevent the one or more documents from losing their status as original.

2. The method of claim 1, wherein the one or more documents being accessed in such a way as to prevent the one or more documents from losing their status as original comprises accessing a version of the one or more documents, the version being an unoriginal copy of the original, the version being modifiable.

3. The method of claim 1, wherein the one or more documents being accessed in such a way as to prevent the one or more documents from losing their status as original comprises accessing the one or more documents in an unmodifiable format, the one or more records being original.

4. The method of claim 1, wherein the one or more documents are accessed from an information governance system that manages the one or more documents, the one or more documents further corresponding to the organization, the information governance system being the external source that transmitted the metric data.

5. The method of claim 4, wherein the one or more documents comprise at least one of the following:
one or more documents associated with a requirement imposed on the organization;
one or more documents not associated with a requirement imposed on the organization; and
one or more documents associated with a litigation matter involving the organization.

6. The method of claim 1, wherein the goal of the organization is selected from the group consisting of:
mitigating a risk of the organization;
achieving a business objective of the organization; and
complying with a requirement imposed on the organization.

7. The method of claim 1, wherein the goal of the organization comprises complying with a requirement imposed on the organization by a federal regulation.

8. A system, comprising:
a processor; and
a program of instructions embodied on a computer-readable medium and operable, upon execution by the processor, to:
provide an interface for defining a control to be used to reach a goal of an organization, the control providing a procedure to be followed by the organization;
provide the interface for implementing the control in order to reach the goal of the organization;
receive metric data from an external source, the metric data including a document link; and
provide the interface for accessing, using the document link, one or more documents corresponding to the control, the one or more documents being accessed in such a way as to prevent the one or more documents from losing their status as original.

9. The system of claim 8, wherein the one or more documents being accessed in such a way as to prevent the one or more documents from losing their status as original comprises accessing a version of the one or more documents, the version being an unoriginal copy of the original, the version being modifiable.

10. The system of claim 8, wherein the one or more documents being accessed in such a way as to prevent the one or more documents from losing their status as original comprises accessing the one or more documents in an unmodifiable format, the one or more documents being original.

11. The system of claim 8, wherein the one or more documents are accessed from an information governance system that manages the one or more documents, the one or more documents further corresponding to the organization, the information governance system being the external source that transmitted the metric data.

12. The system of claim 11, wherein the one or more documents comprise at least one of the following:
one or more documents associated with a requirement imposed on the organization;
one or more documents not associated with a requirement imposed on the organization; and
one or more documents associated with a litigation matter involving the organization.

13. The system of claim 8, wherein the goal of the organization is selected from the group consisting of:
mitigating a risk of the organization;
achieving a business objective of the organization; and
complying with a requirement imposed on the organization.

14. The system of claim 8, wherein the goal of the organization comprises complying with a requirement imposed on the organization by a federal regulation.

15. Logic for governance, risk, and compliance management, the logic encoded on a computer-readable medium and operable, upon execution, to:
provide an interface for defining a control to be used to reach a goal of an organization, the control providing a procedure to be followed by the organization;
provide the interface for implementing the control in order to reach the goal of the organization;
receive metric data from an external source, the metric data including a document link; and
provide the interface for accessing, using the document link, one or more documents corresponding to the control, the one or more documents being accessed in such a way as to prevent the one or more documents from losing their status as original.

16. The logic of claim 15 wherein the one or more documents being accessed in such a way as to prevent the one or more documents from losing their status as original comprises accessing a version of the one or more documents, the version being an unoriginal copy of the original, the version being modifiable.

17. The logic of claim 15, wherein the one or more documents being accessed in such a way as to prevent the one or more documents from losing their status as original comprises accessing the one or more documents in an unmodifiable format, the one or more documents being original.

18. The logic of claim 15, wherein the one or more documents are accessed from an information governance system that manages the one or more documents, the one or more documents further corresponding to the organization, the information governance system being the external source that transmitted the metric data.

19. The logic of claim 18, wherein the one or more documents comprise at least one of the following:
one or more documents associated with a requirement imposed on the organization;
one or more documents not associated with a requirement imposed on the organization; and
one or more documents associated with a litigation matter involving the organization.

20. The logic of claim 15, wherein the goal of the organization is selected from the group consisting of:
mitigating a risk of the organization;
achieving a business objective of the organization; and
complying with a requirement imposed on the organization.

21. The logic of claim 19, wherein the goal of the organization comprises complying with a requirement imposed on the organization by a federal regulation.
